(19) United States
(12) Patent Application Publication
(10) Pub. No.: US 2002/0103676 A1
(43) Pub. Date: Aug. 1, 2002

(54) Medical practice information storage and searching system and medical practice information storage and searching method

(76) Inventors: Seiji Yamaguchi, Tokyo (JP); Katsuya Suzuki, Sagamihara-shi (JP); Masakazu Omoto, Tokyo (JP); Shinichi Omori, Tokyo (JP)

Correspondence Address: Scully, Scott, Murphy & Presser, 400 Garden City Plaza, Garden City, NY, 11530, US

(21) Appl. No.: 10/042,608

(22) Filed: Jan. 9, 2002

(30) Foreign Application Priority Data
Jan. 9, 2001 (JP) 2001-001693

(51) Int. Cl. G06F 17/60

(52) U.S. Cl. 705/3

(57) ABSTRACT

A medical practice information storage and searching system, connected to a network such as the Internet, includes a plurality of local-area information servers for covering local area information in a community, and a general information management server that exchange information with these local-area information servers to generally manage information. With this system, people easily gain access to appropriate medical institutions by searching for the medical institutions.

This application claims benefit of Japanese Application No. 2001-001693 filed in Japan on Jan. 9, 2001 the contents of which are incorporated by this reference.

### BACKGROUND OF THE INVENTION

1. Field of the Invention

The present invention relates to a medical practice information storage and searching system and a medical practice information storage and searching method for allowing people to search for medical practice information of a medical institution.

2. Related Art Statement

Healthcare environment has been improved with a number of medical institutions established in each local area and people receive safe medical treatments at ease. As each medical institution installs sophisticated medical equipment and facilities, advertising the medical institution to potential patients in the local area is important from the standpoint of management so that typically expensive medical equipment and facility are efficiently used.

While healthcare environment is improved, people occasionally have difficulty in finding a medical institution which could provide proper consultation and treatment to a disease when they contract the disease. Some medical institutions may advertise themselves using media, while other medical institutions may find it hard to effectively advertise themselves from the cost/performance point of view.

### OBJECT AND SUMMARY OF THE INVENTION

It is an object of the present invention to provide a medical practice information storage and searching system and a medical practice information storage and searching method with which people easily acquire information relating medical institutions and easily search for an appropriate. medical institution.

A medical practice information storage and searching system of the present invention includes a medical practice information storage unit for receiving medical practice information of a plurality of medical institutions from the plurality of medical institutions through a communication line, a searching criteria receiving unit for receiving, through the communication line, searching criteria in accordance with which the medical practice information stored in the medical practice information storage unit is searched for, and an information delivery unit for searching for the medical practice information in the medical practice information storage unit in accordance with the searching criteria received by the searching criteria receiving unit, and for delivering the searched medical practice information through the communication line.

A medical practice information storage and searching method of the present invention includes a medical practice information storage step for receiving medical practice information of a plurality of medical institutions from the plurality of medical institutions through a communication line and storing the medical practice information into a medical storage unit, a searching criteria receiving step for receiving, at a searching criteria receiving unit through the communication line, searching criteria in accordance with which the medical practice information stored in the medical practice information storage unit is searched for, a medical information searching step for searching for the medical practice information in the medical practice information storage unit in accordance with the searching criteria received by the searching criteria receiving unit, and an information delivery step for delivering the medical practice information, searched in the medical information searching step, through the communication line.

A medical practice information storage and searching system of the present invention includes a first medical practice information input unit, arranged in a first medical institution, for inputting fact information about medical practice conducted by the first medical institution as first medical practice information, a first medical practice information transmitter for transmitting, through a communication line, the first medical practice information input by the first medical practice information input unit, second medical practice information input unit, arranged in a second medical institution, for inputting fact information about medical practice conducted by the second medical institution as second medical practice information, a second medical practice information transmitter for transmitting, through the communication line, the second medical practice information input by the second medical practice information input unit, a medical practice information receiver for receiving, through the communication line, the first medical practice information transmitted from the first medical practice information transmitter and the second medical practice information transmitted from the second medical practice information transmitter, a medical practice information storage unit for storing the first and second medical practice information received by the medical practice information receiver, a medical practice searching information input unit for inputting searching command information that provides a command to search for the first and second medical practice information stored in the medical practice information storage unit, a searching command information transmitter for transmitting the searching command information, input by the medical practice searching information input unit, through the communication line; a searching command information receiver for receiving the searching command information transmitted by the searching command information transmitter through the communication line, a medical practice information searching unit for searching for the first and second medical practice information stored in the medical practice information storage unit in accordance with the searching command information received by the searching command information receiver, a search result information transmitter for transmitting the search result, provided by the medical practice information searching unit, through the communication line, a search result information receiver for receiving the search result, transmitted by the search result information transmitter, through the communication line, and a search result display unit for displaying the search result received by the search result information receiver on display means.

A medical practice information storage and searching method of the present invention includes a first medical practice information input step for inputting first medical practice information from a first medical practice information input unit that inputs fact information about medical practice conducted by a first medical institution as the first medical practice information, a first medical practice information transmitting step for transmitting, through a communication line, the first medical practice information input in the first medical practice information input step, a second medical practice information input step for inputting second medical practice information from a second medical practice information input unit that inputs fact information about medical practice conducted by a second medical institution as the second medical practice information, a second medical practice information transmitting step for transmitting, through the communication line, the second medical practice information input in the second medical practice information input step, a medical practice information receiving step for receiving, through the communication line, the first medical practice information transmitted in the first medical practice information transmitting step and the second medical practice information transmitted in the second medical practice information transmitting step, a medical practice information storage step for storing the first and second medical practice information received in the medical practice information receiving step, a medical practice searching information input step for inputting searching command information that provides a command to search for the first and second medical practice information stored in the medical practice information storage unit, a searching command information transmitting step for transmitting the searching command information, input in the medical practice searching information input step, through the communication line, a searching command information receiving step for receiving the searching command information, transmitted in the searching command information transmitting step, through the communication line, a medical practice information searching step for searching for the first and second medical practice information stored in the medical practice information storage means in accordance with the searching command information received in the searching command information receiving step, a search result information transmitting step for transmitting the search result, provided in the medical practice information searching step, through the communication line, a search result information receiving step for receiving the search result transmitted in the search result information transmitting step through the communication line, and a search result displaying step for displaying the search result received in the search result information receiving step on a display unit.

Other features and advantages of the present invention will become obvious when the following description of the invention is considered.

### BRIEF DESCRIPTION OF THE DRAWINGS

FIG. 1 is a block diagram illustrating a medical practice information storage and searching system in accordance with one embodiment of the present invention;

FIG. 2 is a block diagram illustrating a community medical institution group including clinics, pharmacies, and general hospitals in a local area illustrated in FIG. 1;

FIG. 3 is a flow diagram illustrating the operation of the medical practice information storage and searching system 1 illustrated in FIG. 1;

FIG. 4 is a flow diagram illustrating a system menu screen presented on a user terminal in accordance with the flow diagram illustrated in FIG. 3;

FIG. 5 illustrates an e-mail transmission screen presented on the user terminal in accordance with the flow diagram illustrated in FIG. 3;

FIG. 6 is a flow diagram illustrating the flow of a hospital searching process in accordance with the flow diagram illustrated in FIG. 3;

FIG. 7 is a first diagram illustrating the hospital searching screen presented on the user terminal in accordance with a flow diagram illustrated in FIG. 6;

FIG. 8 is a second diagram illustrating the hospital searching screen presented on the user terminal in accordance with the flow diagram illustrated in FIG. 6;

FIG. 9 is a hospital/geographic information screen presented on the user terminal in accordance with the flow diagram illustrated in FIG. 6;

FIG. 10 is a flow diagram illustrating the flow of a hospital detailed information process in accordance with the flow diagram illustrated in FIG. 6;

FIG. 11 is a diagram illustrating a detailed information selection menu screen presented on the user terminal in accordance with a flow diagram illustrated in FIG. 10;

FIG. 12 is a diagram illustrating an equipment/facility list screen presented on the user terminal in accordance with the flow diagram illustrated in FIG. 10;

FIG. 13 is a diagram illustrating a medicine information selection menu screen presented on the user terminal in accordance with the flow diagram illustrated in FIG. 10;

FIG. 14 is a diagram illustrating the medicine information screen presented on the user terminal in accordance with the flow diagram illustrated in FIG. 10;

FIG. 15 is a flow diagram illustrating the flow of a medical service record information process illustrated in FIG. 10;

FIG. 16 is a diagram illustrating a medical service record information selection menu screen presented on the user terminal in accordance with a flow diagram illustrated in FIG. 15;

FIG. 17 is a first diagram illustrating a patient count display screen presented on the user terminal in accordance with the flow diagram illustrated in FIG. 15;

FIG. 18 is a diagram illustrating an operation count display screen presented on the user terminal in accordance with the flow diagram illustrated in FIG. 15;

FIG. 19 is a diagram illustrating an inpatient count display screen presented on the user terminal in accordance with the flow diagram illustrated in FIG. 15;

FIG. 20 is a diagram illustrating a duration of hospitalization display screen presented on the user terminal in accordance with the flow diagram illustrated in FIG. 15;

FIG. 21 is a diagram illustrating a complete cure rate display screen presented on the user terminal in accordance with the flow diagram illustrated in FIG. 15;

FIG. 22 is a second diagram illustrating the patient count display screen presented on the user terminal in accordance with the flow diagram illustrated in FIG. 15;

FIG. 23 is a third diagram illustrating the patient count display screen presented on the user terminal in accordance with the flow diagram illustrated in FIG. 15;

FIG. 24 is a fourth diagram illustrating the patient count display screen presented on the user terminal in accordance with the flow diagram illustrated in FIG. 15;

FIG. 25 is a flow diagram illustrating the flow of a study result information process illustrated in FIG. 10;

FIG. 26 is a diagram illustrating a study result information selection menu screen presented on the user terminal in accordance with a flow diagram illustrated in FIG. 25;

FIG. 27 is a diagram illustrating a study result chronological table screen presented on the user terminal in accordance with the flow diagram illustrated in FIG. 25;

FIG. 28 is a diagram illustrating the study result display screen presented on the user terminal in accordance with the flow diagram illustrated in FIG. 25;

FIG. 29 is a diagram illustrating a subject of study chronological table screen presented on the user terminal in accordance with the flow diagram illustrated in FIG. 25;

FIG. 30 is a diagram illustrating a researcher chronological table screen presented on the user terminal in accordance with a flow diagram illustrated in FIG. 25;

FIG. 31 is a diagram illustrating a keyword searching list screen presented on the user terminal in accordance with the flow diagram illustrated in FIG. 25;

FIG. 32 is a flow diagram illustrating the flow of a medical staff information process illustrated in FIG. 10;

FIG. 33 is a diagram illustrating a medical staff information selection menu screen presented on the user terminal in accordance with the flow diagram illustrated in FIG. 32;

FIG. 34 is a diagram illustrating a staff member count display screen presented on the user terminal in accordance with the flow diagram illustrated in FIG. 32;

FIG. 35 is a diagram illustrating a physicians' medical career display screen presented on the user terminal in accordance with the flow diagram illustrated in FIG. 32;

FIG. 36 is a flow diagram illustrating the flow of an action to request process illustrated in FIG. 10;

FIG. 37 is a diagram illustrating an action to request information selection menu screen presented on the user terminal in accordance with a flow diagram illustrated in FIG. 36;

FIG. 38 is a diagram illustrating a request list display screen presented on the user terminal in accordance with the flow diagram illustrated in FIG. 36;

FIG. 39 is a diagram illustrating an action to request information screen presented on the user terminal in accordance with the flow diagram illustrated in FIG. 36;

FIG. 40 is a diagram illustrating a search request list screen presented on the user terminal in accordance with the flow diagram illustrated in FIG. 36;

FIG. 41 is a flow diagram illustrating the flow of a request for consultation process illustrated in FIG. 3;

FIG. 42 is a diagram illustrating a hospital searching screen presented on the user terminal in accordance with a flow diagram illustrated in FIG. 41;

FIG. 43 is a flow diagram illustrating the flow of a request for consultation in a special hospital illustrated in FIG. 41;

FIG. 44 is a diagram illustrating a request for consultation screen presented on the user terminal in accordance with a flow diagram illustrated in FIG. 43;

FIG. 45 is a diagram illustrating a request acceptance screen presented on the user terminal in accordance with the flow diagram illustrated in FIG. 43;

FIG. 46 is a flow diagram illustrating the flow of a personal information searching process illustrated in FIG. 3;

FIG. 47 is a diagram illustrating a personal information searching screen presented on the user terminal in accordance with a flow diagram illustrated in FIG. 46;

FIG. 48 is a diagram illustrating a personal patient record chronological table screen presented on the user terminal in accordance with the flow diagram illustrated in FIG. 46;

FIG. 49 is a diagram illustrating a detailed information screen presented on the user terminal in accordance with the flow diagram illustrated in FIG. 46;

FIG. 50 is a flow diagram illustrating the flow of a transport information searching process illustrated in FIG. 3;

FIG. 51 is a diagram illustrating a transport information searching screen presented on the user terminal in accordance with a flow diagram illustrated in FIG. 50;

FIG. 52 is a diagram illustrating a transport information search result screen presented on the user terminal in accordance with the flow diagram illustrated in FIG. 50;

FIG. 53 is a flow diagram showing the flow of a food-service company information searching process illustrated in FIG. 3;

FIG. 54 is a food-service company information searching screen presented on the user terminal in accordance with a flow diagram illustrated in FIG. 53;

FIG. 55 is a diagram illustrating a dining menu screen presented on the user terminal in accordance with the flow diagram illustrated in FIG. 53;

FIG. 56 is a flow diagram illustrating the flow of a life insurance information searching process illustrated in FIG. 3;

FIG. 57 is a diagram illustrating a life insurance information search result screen presented on the user terminal in accordance with the flow diagram illustrated in FIG. 56;

FIG. 58 is a diagram illustrating a life insurance information search result screen presented on the user terminal in accordance with the flow diagram illustrated in FIG. 56; and

FIG. 59 is a diagram illustrating a content comparison screen presented on the user terminal in accordance with the flow diagram illustrated in FIG. 56.

### DETAILED DESCRIPTION OF THE PREFERRED EMBODIMENTS

Referring to the drawings, one embodiment of the present invention will now be discussed.

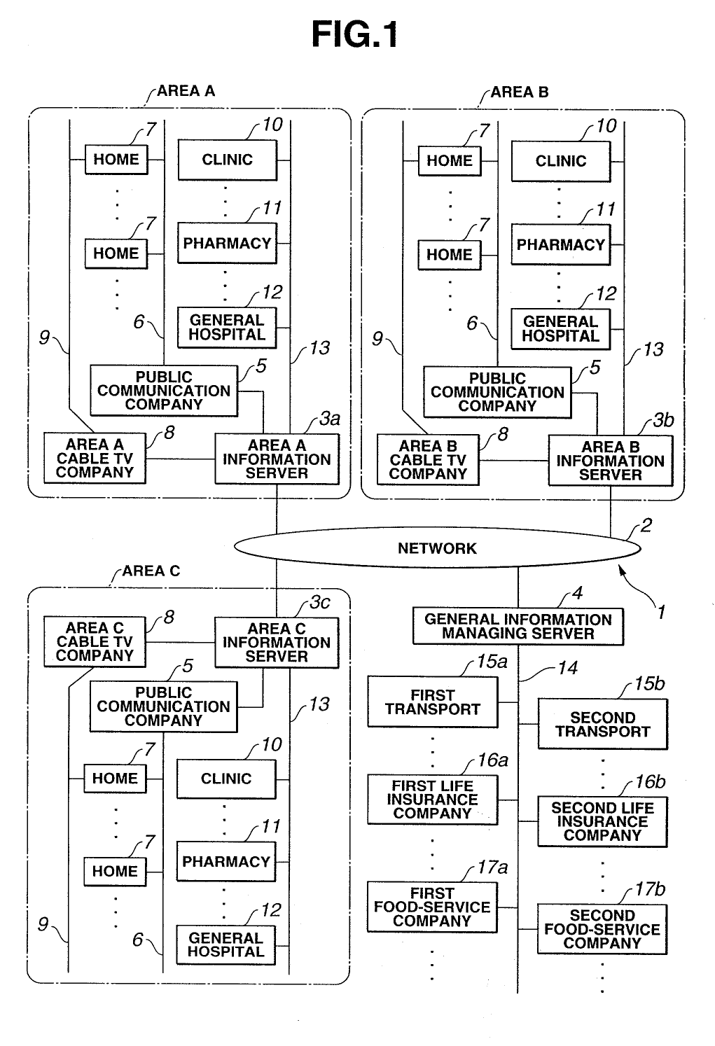

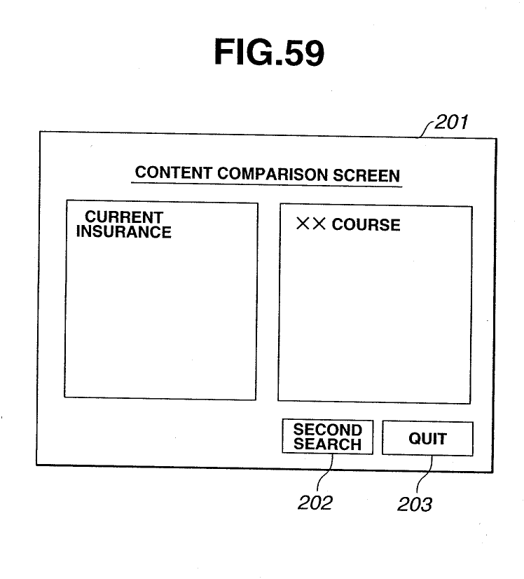

FIG. 1 through FIG. 59 illustrate the one embodiment of the present invention.

Referring to FIG. 1, a medical practice information storage and searching system 1 of this embodiment includes a plurality of local-area information servers 3 (such as a local area A information server 3a, a local area B information server 3b, a local area C information server 3c, . . . ) connected to a network 2 such as the Internet, and a general information management server 4 that exchanges information with the plurality of local-area information servers 3 to manage information.

Each of the plurality of local-area information servers 3 is connected to homes 7 that subscribe to a public communication company 5 through a public communication line 6. When the homes 7 are connected to a cable TV, exchange. of information is performed through a communication cable 9 of a local-area cable TV 8 in each local area. The plurality of local-information servers 3 exchange information with a clinic 10, a pharmacy 11, and a general hospital 12, etc. in the local area via a dedicated line 13.

On the other hand, the general information management server 4 exchanges information with the plurality of local-information servers 3 through the above-discussed network 2. The general information management server 4 also exchanges information, through a dedicated line 14, with a plurality of transports 15 (including a first transport 15a, a second transport 15b, . . . ) such as railway companies and bus companies, a plurality of life insurance companies 16 (a first life insurance company 16a, a second life insurance company 16b, . . . ), and a plurality of food-service companies 17 (a first food-service company 17a, a second food-service company 17b, . . . ) such as restaurants.

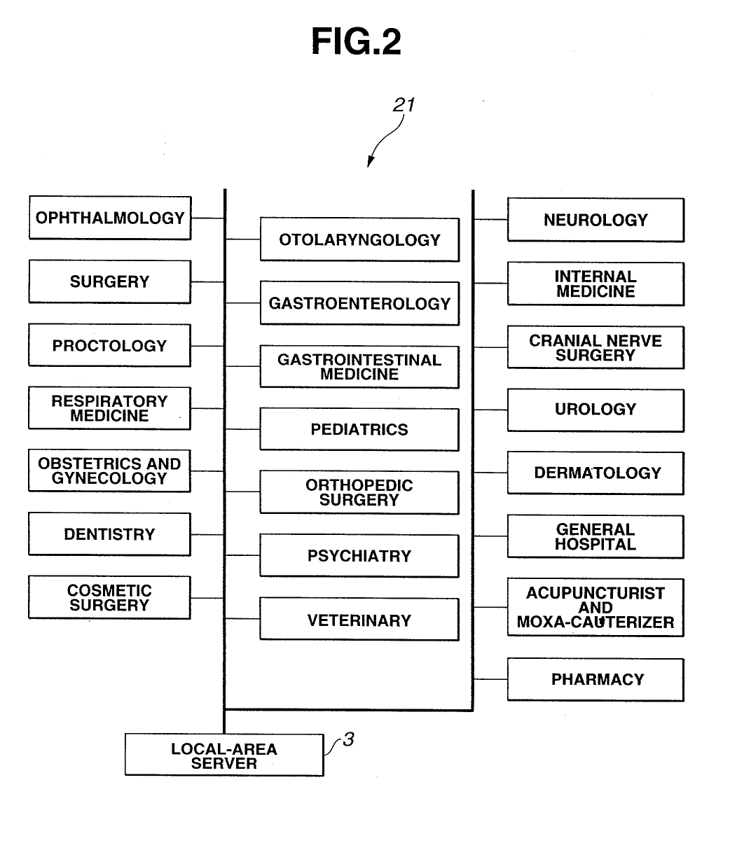

Referring to FIG. 2, the plurality of local-information servers 3 establishes a community medical institution group 21, which is composed the clinic 10, the pharmacy 11, and the general hospital 12, and covers ophthalmology, surgery, proctology, respiratory medicine, obstetrics and gynecology, dentistry, cosmetic surgery, otolaryngology, gastroenterology, gastrointestinal medicine, pediatrics, orthopedic surgery, psychiatry, neurology, internal medicine, cranial nerve surgery, urology, dermatology, a general hospital, acupuncturist and moxa-cauterizer, veterinarian pharmacy, etc. The plurality of local-information servers 3 thus exchange a diversity of pieces of medical information with the clinic 10, the pharmacy 11, and the general hospital 12.

In the medical practice information storage and searching system 1, the general information management server 4 opens a home page on the network 2 and provides on the home page, a variety of pieces of medical information of the community medical institution group 21, composed of the clinic 10, the pharmacy 11 and the general hospital 12, obtained through the local-information servers 3, transport information such as schedules from the transport 15, insurance information from the life insurance company 16, dining menu information from the food-service company 17.

The operation of the medical practice information storage and searching system 1 thus constructed is described hereinafter.

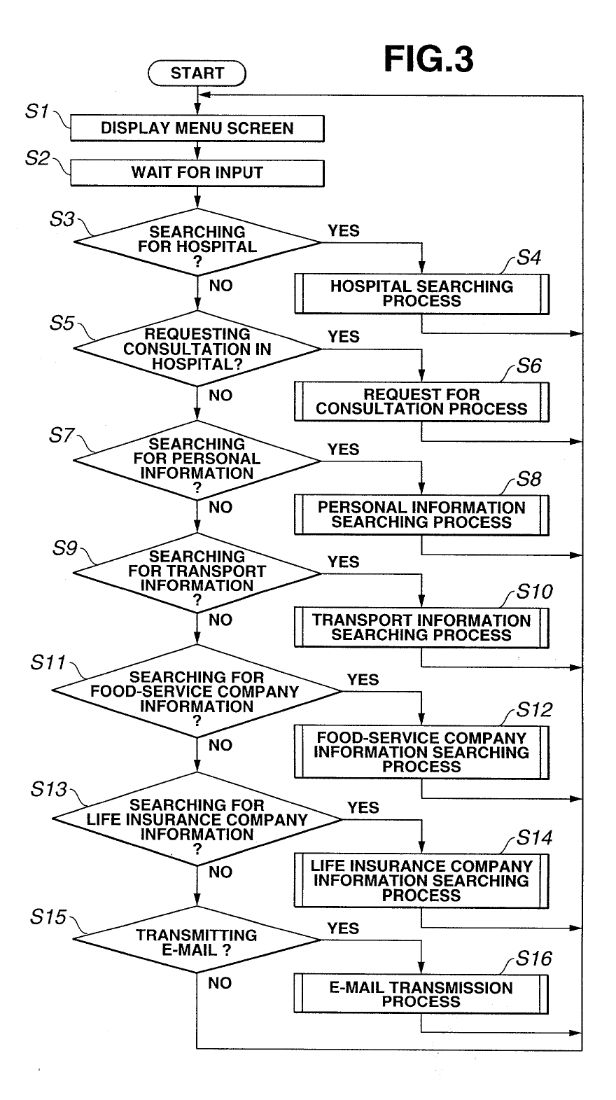

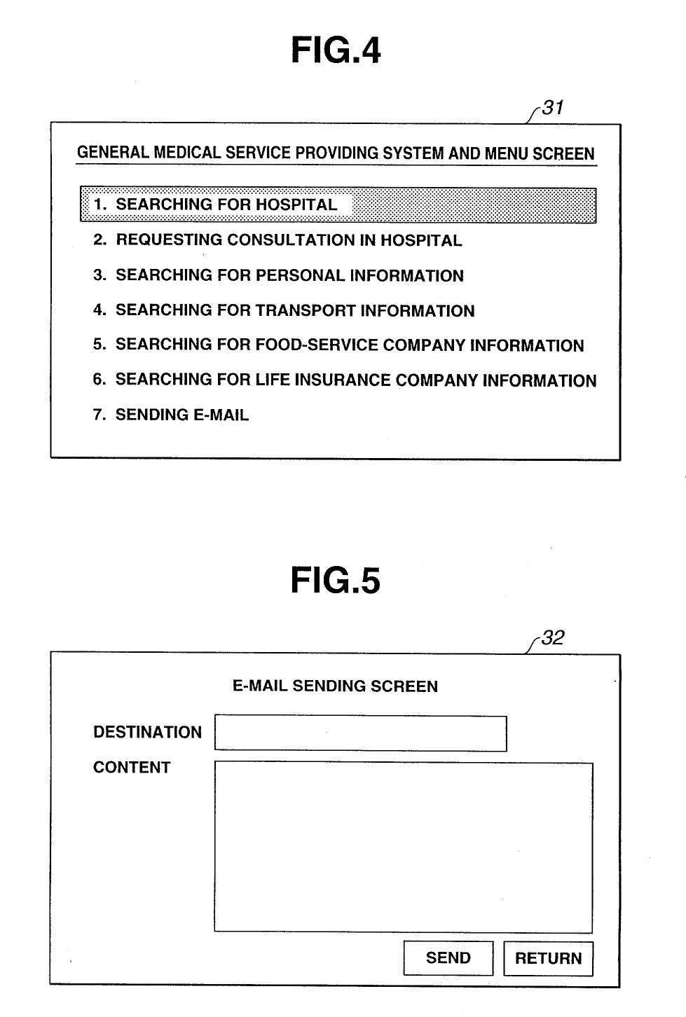

The general information management server 4 opens the home page on the network 2. When a user at a home 7 accesses the home page in step S1 as shown in FIG. 3, the general information management server 4 displays a system menu screen 31 of the medical practice information storage and searching system on a terminal of the user as shown in FIG. 4.

The system menu screen 31 lists a hospital searching item for searching for hospitals included in the community medical institution group 21, a request for consultation item for requesting consultation in a hospital, a personal information searching item for searching for the clinical record of each user, a transport information searching item for searching for transport information relating to each individual medical institution of the community medical institution group 21 obtained from the transport 15, a food-service company information searching item for searching for dining menu information obtained from the food-service company 17 and appropriate for the symptom of each user, a life insurance information searching item for searching for a variety of pieces of insurance information obtained from the life insurance company 16, and an e-mail transmission item for transmitting a request, etc., to each medical institution. The user selects or inputs each desired item on the system menu screen 31 using a keyboard or a mouse, and the medical practice information storage and searching system 1 waits for an input from the user in step S2.

When the input is received from the user, the system determines in step S3 whether the item input in step S3 is the hospital searching item. When it is determined in step S3 that the input item is the hospital searching item, the hospital searching process discussed later is performed in step S4. The routine then loops to step S1. When it is determined in step S3 that the input item is not the hospital searching item, the routine proceeds to step S5.

In step S5, the system determines whether the input item is the request for consultation searching item. When it is determined that the input item is the request for consultation item, a request for consultation process discussed later is performed in step S6. The routine then loops to step S1. When it is determined in step S5 that the input item is not the request for consultation item, the routine proceeds to step S7.

In step S7, the system determines whether the input item is the personal information searching item. When it is determined that the input item is the personal information searching item, a personal information searching process discussed later is performed in step S8, and the routine then loops to step S1. When it is determined in step 57 that the input item is not the personal information searching item, the routine proceeds to step S9.

In step S9, the system determines whether the input item is the transport information searching item. When it is determined that the input item is the transport information searching item, a personal information searching process discussed later is performed in step S10, and the routine then loops to step S1. When it is determined in step S9 that the input item is not the transport information searching item, the routine proceeds to step S11.

In step S11, the system determines whether the input item is the food-service company information searching item. When it is determined that the input item is the food-service company information searching item, a food-service company information searching process discussed later is performed in step S12, and then the routine loops to step S1. When it is determined in step S11 that the input item is not the food-service company information searching item, the routine proceeds to step S13.

In step S13, the system determines whether the input. item is the life insurance information searching item. When it is determined that the input item is the life insurance information searching item, a life insurance information searching process discussed later is performed in step S14, and then the routine loops to step S1. When it is determined that the input item is not the life insurance information searching item, the routine proceeds to step S15.

In step S15, the system determines whether the input item is the e-main transmission item when it is determined the input item is the e-mail transmission item, an e-mail transmission screen 32 shown in FIG. 5 is displayed in step S16. An e-mail transmission process for transmitting a request from the user to a hospital as a destination is performed, and then the routine loops to step S1. When the input item is not the e-mail transmission item, the routine loops to step S1.

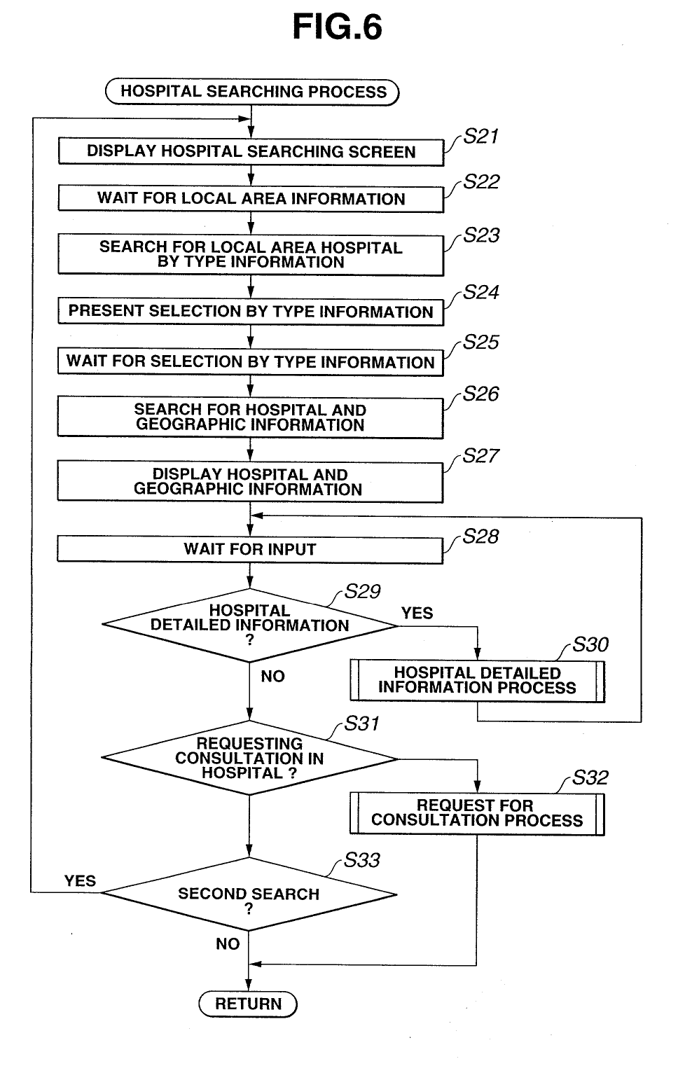

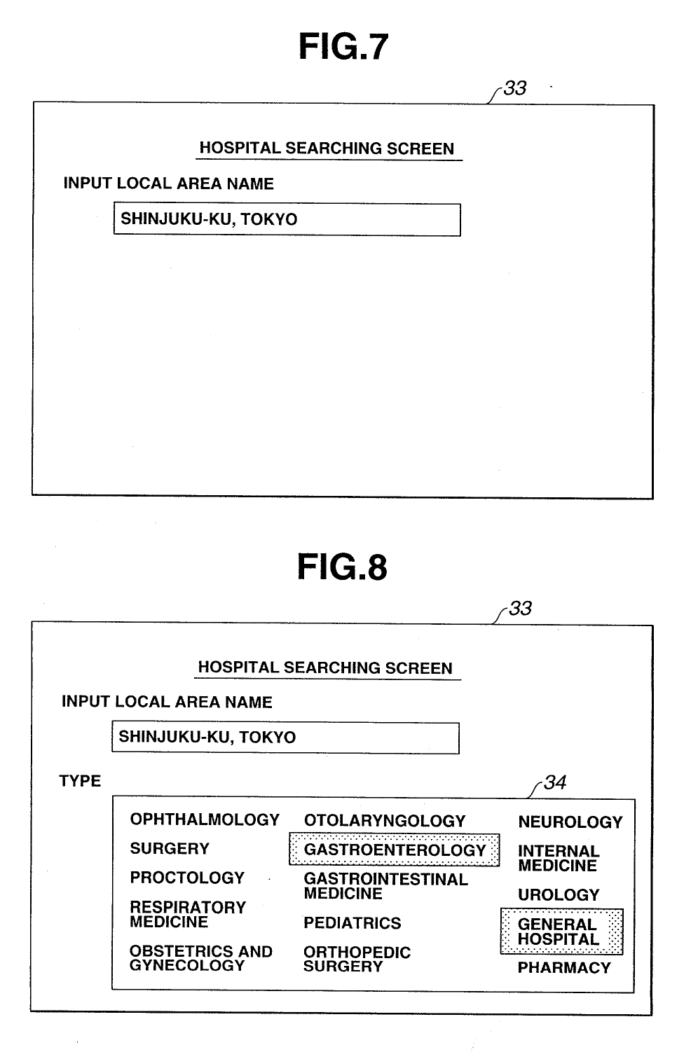

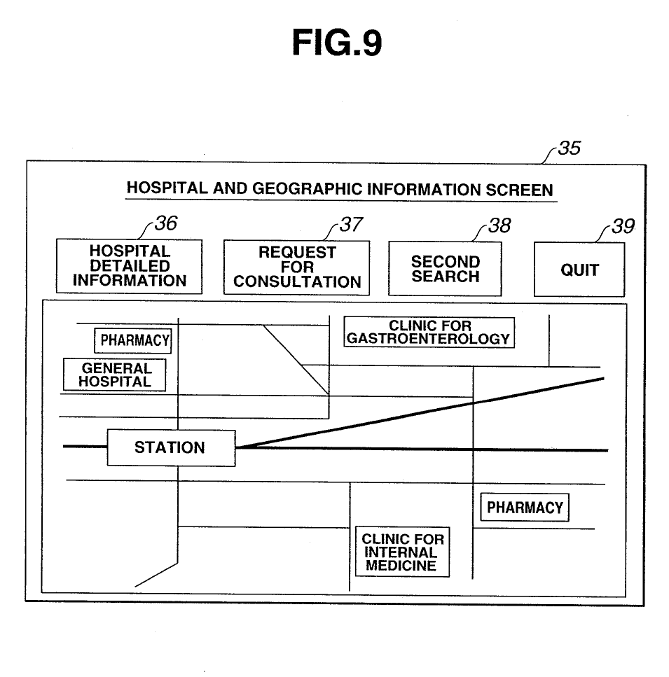

The hospital searching process in step S4 in FIG. 3 is discussed hereinafter. In the hospital searching process, a hospital searching screen 33 shown in FIG. 7 is presented on the user terminal in step S21 as shown in FIG. 6. In step S22, the system waits for the input of local area information such as the name of a local area for searching in the hospital searching screen 33. When the local area information is input, local-area hospital type information indicating the type of each of the medical institutions in the local area is searched for based on the local area information input in step S23. The medical institutions searched in step S24, namely, the local-area hospital type information, is displayed as selection by type information 34 on the hospital searching screen 33. In step S25, the system waits for the user input of a type of the medical institutions for performing a search on the selection by type information 34 on the hospital searching screen 33. In step S26, the input medical institutions are searched for by type. In step S27, the map of the hospital of the type is presented on a hospital and geographic information screen 35 as shown in FIG. 9.

The hospital and geographic information screen 35 presents a hospital detailed information button 36 for a hospital detailed information process for obtaining detailed information of each hospital, a request for consultation button 37 for requesting a medical consultation in the hospital, a second search button 38 for searching for the hospitals again, and a quit bottom 39 for quitting the process. The user selects each of these buttons using the keyboard or the mouse. In step S28, the system waits for an input selected by the user.

In step S29, the system determines whether the input selected on the hospital and geographic information screen 35 is the hospital detailed information button 36. When it is determined that the input selected on the hospital and geographic information screen 35 is the hospital detailed information button 36, the system performs, in step S30, the hospital detailed information process to be discussed later, and then the routine loops to step S27. When it is determined in step S29 that the input selected on the hospital and geographic information screen 35 is not the hospital detailed information button 36, the routine proceeds to step S31.

In step S31, the system determines whether the input selected on the hospital and geographic information screen 35 is the request for consultation button 37. When it is determined that the input selected on the hospital and geographic information screen 35 is the request for consultation button 37, the system performs the request for consultation process discussed later in step S32, and then returns to step S1 shown in FIG. 3. When it is determined in step S37 that the input selected on the hospital and geographic information screen 35 is not the request for consultation button 37, the routine then proceeds to step S33.

In step S33, the system determines whether the input selected on the hospital and geographic information screen 35 is the second search button 38. When it is determined that the input selected on the hospital and geographic information screen 35 is the second search button 38, the routine then loops to S21. When it is determined that the input selected on the hospital and geographic information screen 35 is not the second search button 38, the input must be the quit bottom 39. The system quits the process, and then returns to step S1 in FIG. 3.

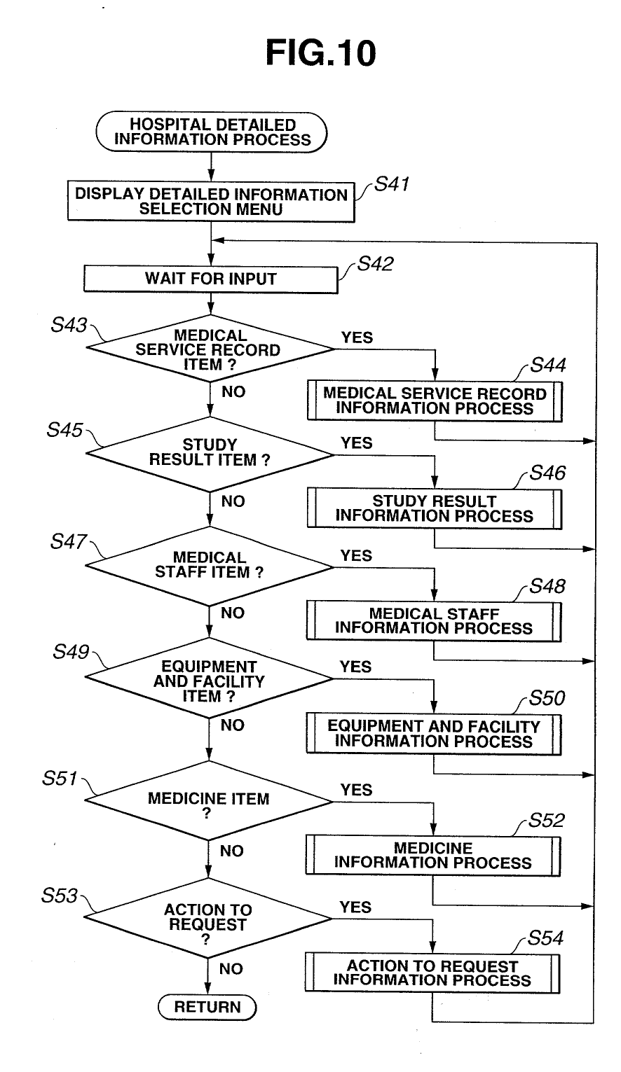

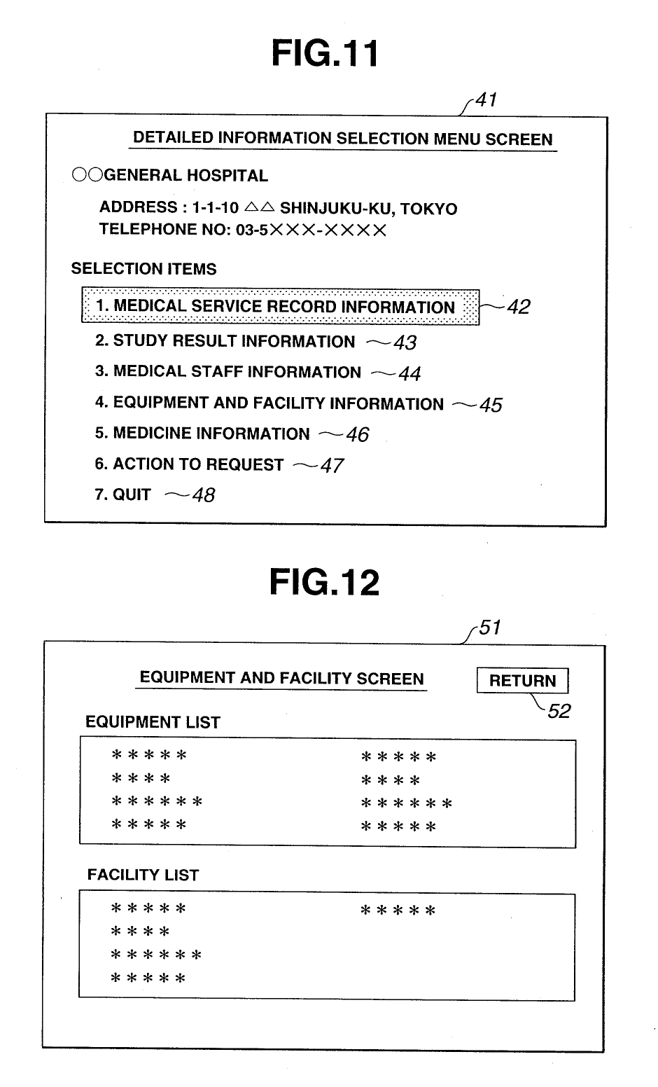

The hospital detailed information process in step S29 illustrated in FIG. 6 will now be discussed. In the hospital detailed information process, a detailed information selection menu screen 41 illustrated in FIG. 11 is presented on the user terminal in step S41 as illustrated in FIG. 10.

The detailed information selection menu screen 41 presents the address and telephone number of the searched hospital, and selection items for selecting detailed information. These selection items include a medical service record information item 42 for disclosing information about a patient count of the hospital, etc., a study result information item 43 for disclosing the results of studies performed by the hospital, a medical staff information item 44 for disclosing information about medical staff of the hospital, an equipment and facility information item 45 for disclosing information about medical equipment and facility in the hospital, a medicine information item 46 for disclosing information about medicines administered in the hospital, an action to request item 47 for disclosing information about the action to a request sent to the hospital in the course of the e-mail transmission in step S16 illustrated in FIG. 3, and a quit menu 48 for quitting the hospital detailed information process. The user selects each of these items using the keyboard or the mouse. In step S42, the system waits for an input selected by the user.

In step S43, the system determines whether the input selected on the detailed information selection menu screen 41 is the medical service record information item 42. When it is determined that the input selected on the detailed information selection menu screen 41 is the medical service record information item 42, the system performs, in step S44, a medical service record information process to be discussed later, and then loops to step S42. When it is determined in step S43 that the input selected on the detailed information selection menu screen 41 is not the medical service record information item 42, the routine proceeds to step S45.

In step S45, the system determines whether the input selected on the detailed information selection menu screen 41 is the study result information item 43. When it is determined that the input selected on the detailed information selection menu screen 41 is the study result information item 43, the system performs, in step S46, a study result information process to be discussed later, and then loops to step S42. When it is determined in step S45 that the input selected on the detailed information selection menu screen 41 is not the study result information item 43, the routine proceeds to step S47.

In step S47, the system determines whether the input selected on the detailed information selection menu screen 41 is the medical staff information item 44. When it is determined that the input selected on the detailed information selection menu screen 41 is the medical staff information item 44, the system performs, in step S48, a medical staff information process to be discussed later, and then loops to step S42. When it is determined that the input selected on the detailed information selection menu screen 41 is not the medical staff information item 44, the routine proceeds to step S49.

In step S49, the system determines whether the input selected on the detailed information selection menu screen 41 is the equipment and facility information item 45. When it is determined that the input selected on the detailed information selection menu screen 41 is the equipment and facility information item 45, the system performs, in step S50, an equipment and facility information process. An equipment and facility list screen 51 illustrated in FIG. 12 is displayed and thus disclosed on the user terminal. If a return button 52 is pressed on the equipment and facility list screen 51, the routine loops to step S42. When it is determined in step S49 that the input selected on the detailed information selection menu screen 41 is not the equipment and facility information item 45, the routine proceeds to step S51.

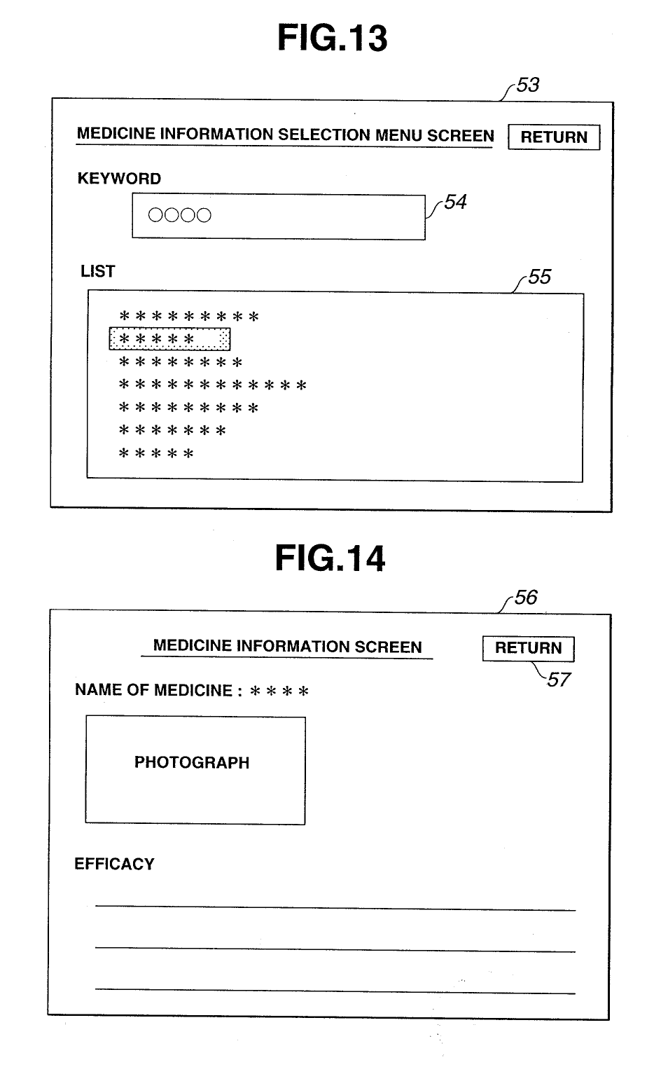

In step. S51, the system determines whether the input selected on the detailed information selection menu screen 41 is the medicine information item 46. When it is determined that the input selected on the detailed information selection menu screen 41 is the medicine information item 46, the system performs, in step S52, a medicine information process by displaying a medicine information selection menu screen 53 on the user terminal as illustrated in FIG. 13. When it is determined in step S51 that the input selected on the detailed information selection menu screen 41 is not the medicine information item 46, the routine proceeds to step S53.

The medicine information selection menu screen 53 includes a keyword input area 54 to which a keyword relating to a medicine is input. When the user inputs a keyword, a medicine list 55 corresponding to the input keyword is displayed. By selecting the name of a desired medicine in the medicine list 55 using a mouse, etc., a medicine information screen 56 shown in FIG. 14 is presented on the user terminal. Detailed information such as a photograph and efficacy of the medicine is thus disclosed. When a return button 57 is pressed on the medicine information screen 56, the routine loops to step S42.

In step S53, the system determines whether the input selected on the detailed information selection menu screen 41 is the action to request item 47. When it is determined that the input selected on the detailed information selection menu screen 41 is the action to request item 47, the system performs, in step S54, an action to request process to be discussed later, and then loops to step S42. When it is determined in step S53 that the input selected on the detailed information selection menu screen 41 is not the action to request item 47, the selected input must be the quit menu 48. The system ends the process, and returns to step S27 in FIG. 6.

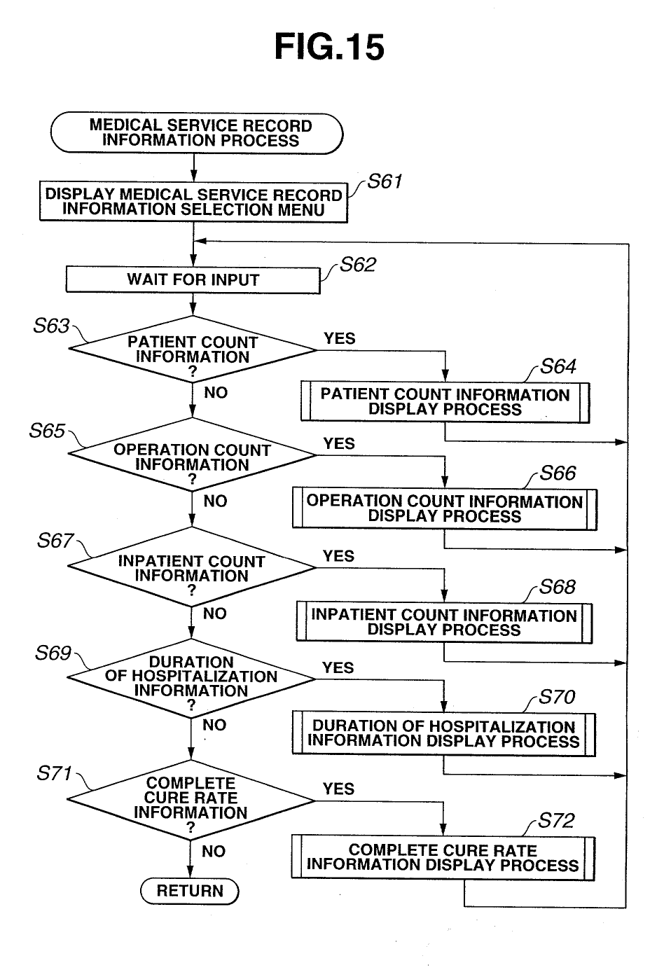

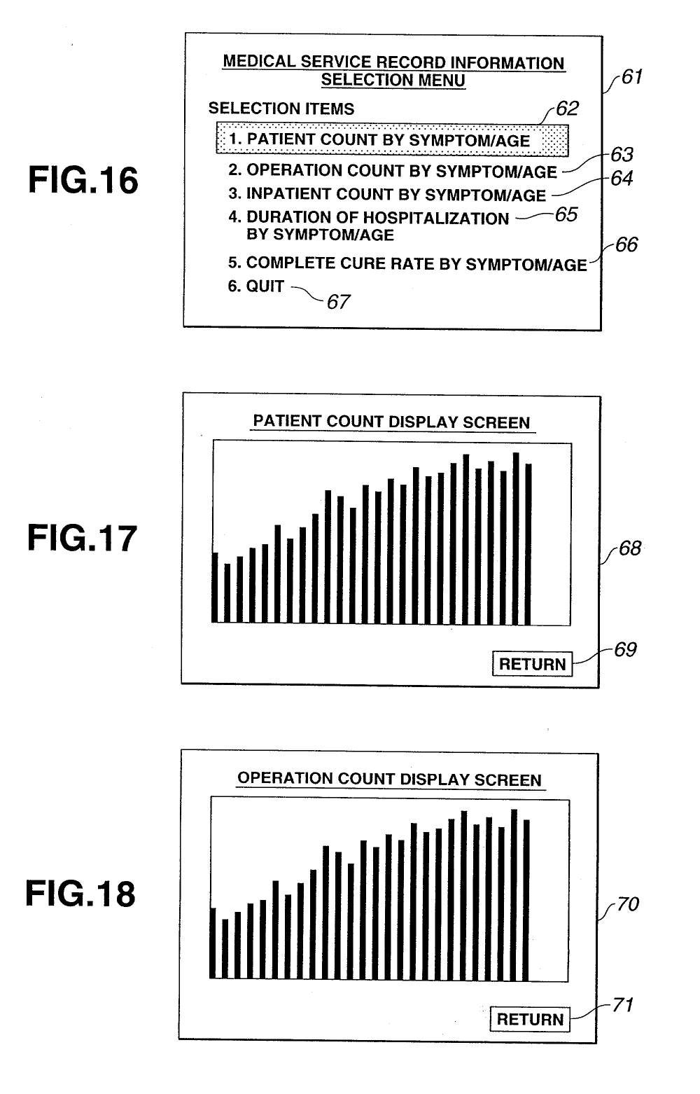

The medical service record information process in step S44 illustrated in FIG. 10 is discussed hereinafter. In the medical service record information, a medical service record information selection menu screen 61 illustrated in FIG. 16 is presented on the user terminal in step S61 as illustrated in FIG. 15.

The medical service record information selection menu screen 61 includes selection items for selecting the medical service record information of the searched hospital. These selection items include a patient count item 62 for disclosing information about a patient count by symptom/age, an operation count item 63 for disclosing information about an operation count by symptom/age, an inpatient count item 64 for disclosing information about an inpatient count by symptom/age, a duration of hospitalization item 65 for disclosing information about a duration of hospitalization by symptom/age, a complete cure rate item 66 for disclosing information about a complete cure rate by symptom/age, and a quit menu 67 for quitting the hospital detailed information process. The user thus selects each of these items using the keyboard or the mouse. In step S62, the system waits for an input selected by the user.

In step S63, the system determines whether the input selected on the medical service record information selection menu screen 61 is the patient count item 62. When it is determined that the input selected on the medical service record information selection menu screen 61 is the patient count item 62, the system performs a patient count information display process in step S64, thereby displaying a patient count display screen 68 on the user terminal as illustrated in FIG. 17. Trend data of the patient count over the past several years is thus disclosed. If a return button 69 is pressed on the patient count display screen 68, the routine loops to step S62. When it is determined in. step S63 that the input selected on the medical services record information selection menu screen 61 is not the patient count item 62, the routine proceeds to step S65.

In step S65, the system determines whether the input selected on the medical service record information selection menu screen 61 is the operation count item 63. When it is determined that the input selected on the medical service record information selection menu screen 61 is the operation count item 63, the system performs an operation count information display process in step S66, thereby presenting an operation count display screen 70 on the user terminal as illustrated in FIG. 18. Trend data of the operation count over the past several years is thus disclosed. If a return button 71 is pressed on the operation count display screen 70, the routine loops to step S62. When it is determined in step S65 that the input selected on the medical service record information selection menu screen 61 is not the operation count item 63, the routine proceeds to step S67.

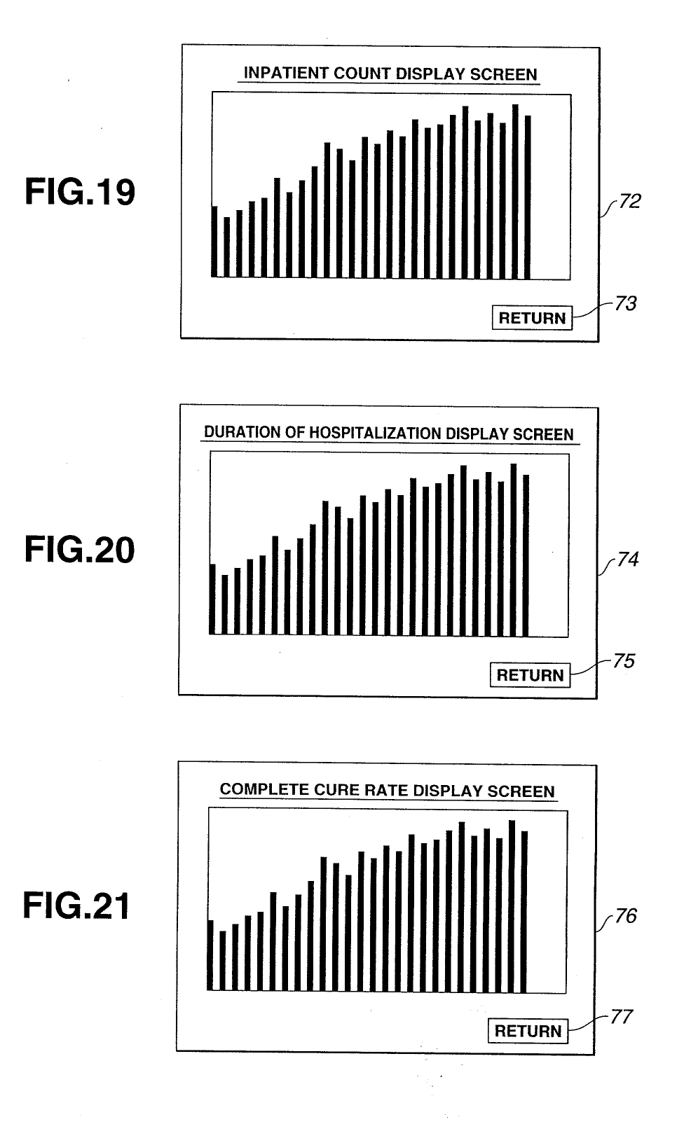

In step S67, the system determines whether the input selected on the medical service record information selection menu screen 61 is the inpatient count item 64. When it is determined that the input selected on the medical service record information selection menu screen 61 is the inpatient count item 64, the system performs an inpatient count information display process in step S68, thereby presenting an inpatient count display screen 72 on the user terminal as illustrated in FIG. 19. Trend data of the inpatient count over the past several years is thus disclosed. If a return button 73 is pressed on the inpatient count display screen 72, the routine loops to step S62. When it is determined in step S67 that the input selected on the medical service record information selection menu screen 61 is not the inpatient count item 64, the routine proceeds to step S69.

In step S69, the system determines whether the input selected on the medical service record information selection menu screen 61 is the duration of hospitalization item 65. When it is determined that the input selected on the medical service record information selection menu screen 61 is the duration of hospitalization item 65, the system performs a duration of hospitalization information display process in step S68, thereby presenting a duration of hospitalization display screen 74 as illustrated in FIG. 20. Trend data of the duration of hospitalization over the past several years is thus disclosed. If a return button 75 is pressed on the duration of hospitalization display screen 74, the routine loops to step S62. When it is determined in step S69 that the input selected on the medical service record information selection menu screen 61 is not the duration of hospitalization item 65, the routine proceeds to step S71.

In step S71, the system determines whether the input selected on the medical service record information selection menu screen 61 is the complete cure rate item 66. When it is determined that the input selected on the medical service record information selection menu screen 61 is the complete cure rate item 66, the system performs a complete cure rate information display process in step S72, thereby presenting a complete cure rate display screen 76 on the user terminal as illustrated in FIG. 21. Trend data of the complete cure rate over the past several years is thus disclosed. If a return button 77 is pressed on the complete cure rate display screen 76, the routine loops to step S62. When it is determined in step S71 that the input selected on the medical service record information selection menu screen 61 is not the complete cure rate item 66, the selected input must be the quit menu 67. The system ends the process, and then returns to step S42 illustrated in FIG. 10.

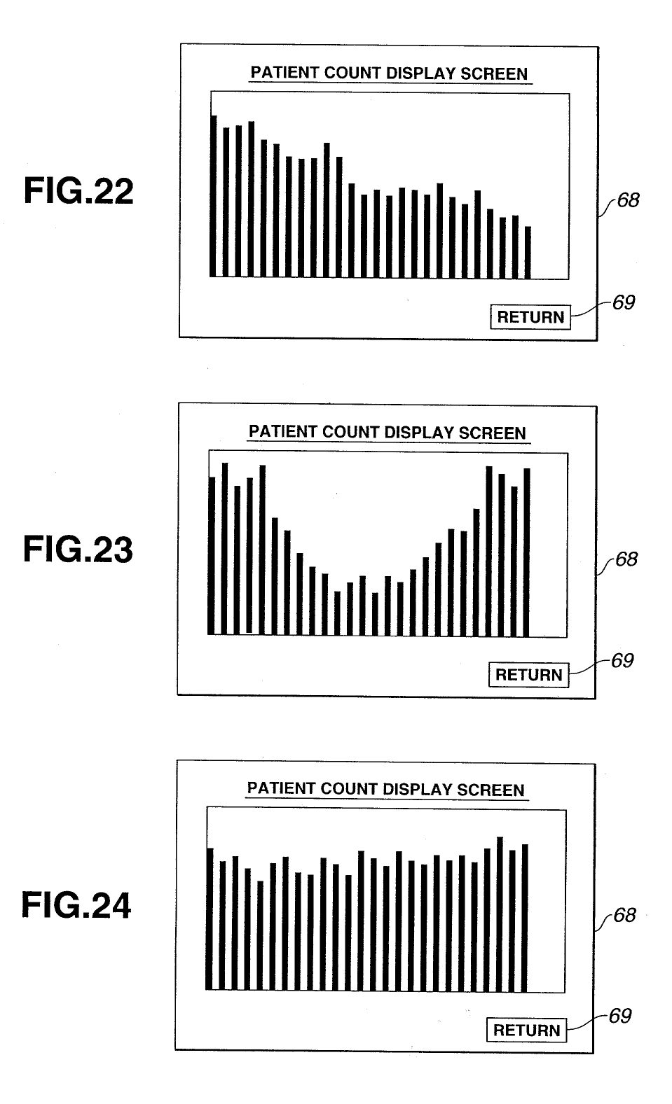

The trend data of the medical service record disclosed in the medical service record information process is used in the selection of a hospital. For example, the trend data of the patient count is now considered. Now, the patient count in a hospital A is indicated as shown in FIG. 17 while the patient count in a hospital A is indicated as shown in FIG. 22. Since the hospital A having an increasing trend in the number of patients is thought of as being more popular than the hospital B having a decreasing trend in the number of patients, people naturally choose the hospital A, expecting a more reliable treatment in the hospital A. A hospital shown in FIG. 23 has substantial variations in the patient count thereof while a hospital shown in FIG. 24 has less variation in the patient count thereof. People choose the hospital shown in FIG. 24, expecting a reliable medical treatment in that hospital. The trend data disclosed in this way is used in the selection of hospitals.

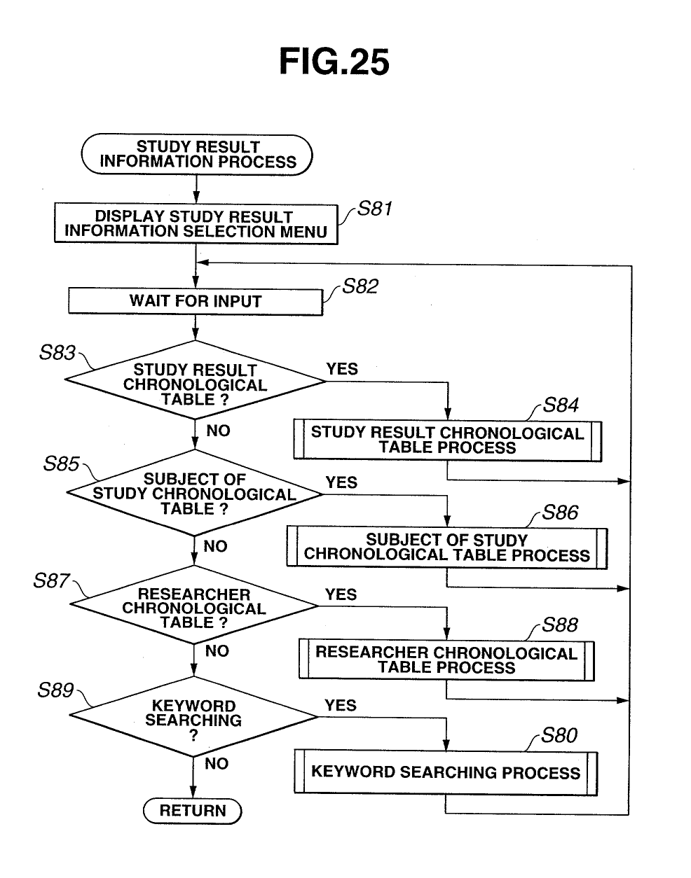

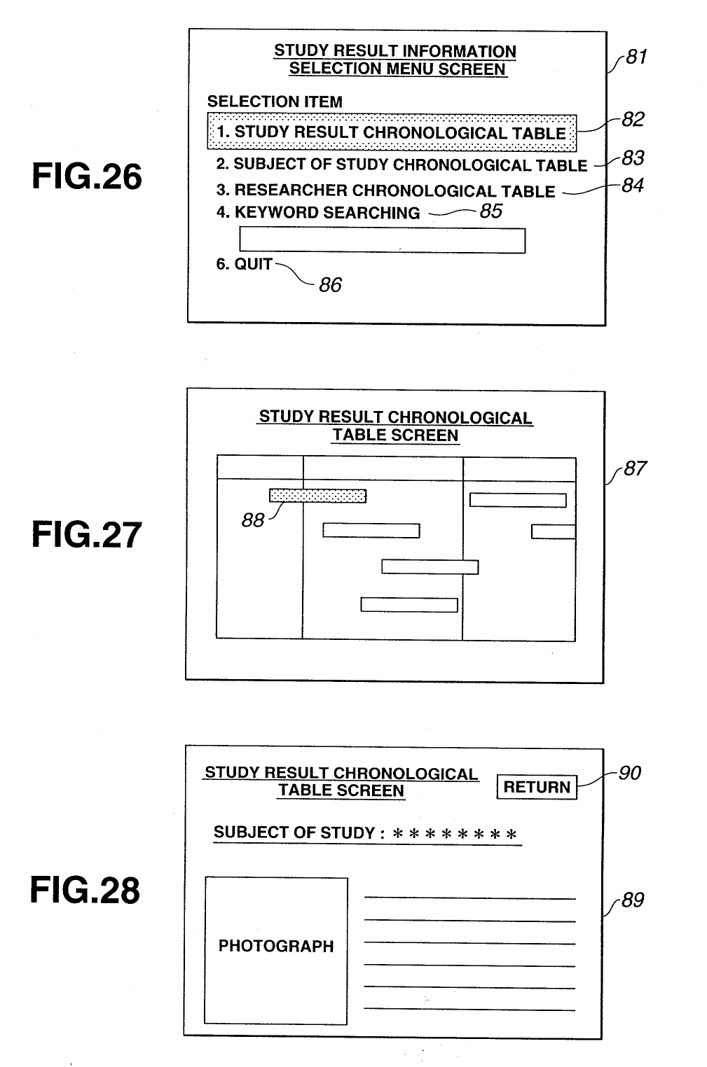

The study result information process in step S46 illustrated in FIG. 10 is discussed hereinafter. In the study result information process, a study result information selection menu screen 81 illustrated in FIG. 26 is presented on the user terminal in step S81 as illustrated in FIG. 25.

The study result information selection menu screen 81 lists selection items for selecting the study result information of the searched hospital. These selection items include a study result chronological table item 82 for disclosing information about all recent study results, a subject of study chronological table item 83 for disclosing information about the recent study results classified according to subject, a researcher chronological table item 84 for disclosing information about the recent study results classified according to researcher, a keyword item 85 in which the information of the study results is searched for in accordance with a keyword, and a quit menu 86 for quitting the study result information process. The user selects each of these items using the keyboard or the mouse. The user may also input a keyword to search for the information of the study results. In step S82, the system waits for an input selected by the user.

In step S83, the system determines whether the input selected on the study result information selection menu screen 81 is the study result chronological table item 82. When it is determined that the input selected on the study result information selection menu screen 81 is the study result chronological table item 82, the system performs a study result chronological table process in step S84, thereby presenting a study result chronological table screen 87 on the user terminal as illustrated in FIG. 27. All recent study results are thus disclosed. If the subject of a study 88 is selected on the study result chronological table screen 87 with the mouse, etc., a study result display screen 89 is presented on the user terminal as shown in FIG. 28. The study result display screen 89 discloses the detailed content of the study. If a return button 90 is pressed on the study result display screen 89, the routine loops to step S82. When it is determined in step S83 that the input selected on the study result information selection menu screen 81 is not the study result chronological table item 82, the routine proceeds to step S85.

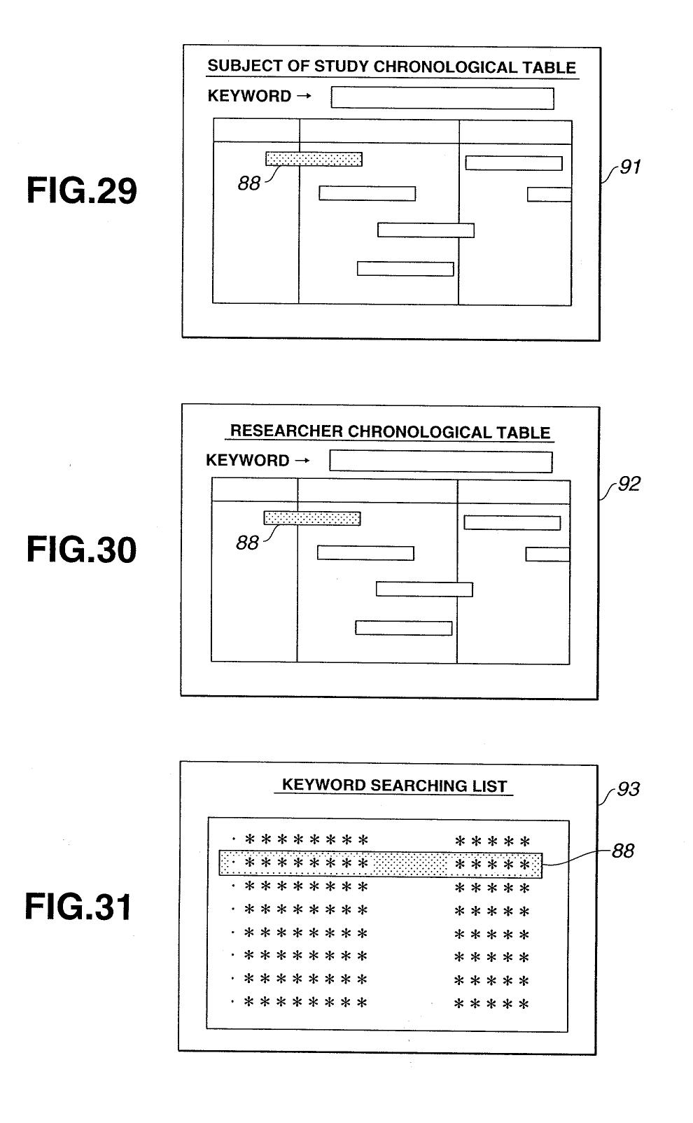

In step S85, the system determines whether the input selected on the study result information selection menu screen 81 is the subject of study chronological table item 83. When it is determined that the input selected on the study result information selection menu screen 81 is the subject of study chronological table item 83, the system performs a subject of study chronological table process in step S86, thereby presenting a subject of study chronological table screen 91 on the user terminal as illustrated in FIG. 29. The results of the recent studies classified according to study subject are thus disclosed. If the study subject 88 is selected on the subject of study chronological table screen 91 using the mouse, etc., the study result display screen 89 is presented on the user terminal as shown in FIG. 28. If a return button 90 is pressed on the study result display screen 89, the routine loops to step S82. When it is determined in step S85 that the input selected on the study result information selection menu screen 81 is not the subject of study chronological table item 83, the routine proceeds to step S87.

In step S87, the system determines whether the input selected on the study result information selection menu screen 81 is the researcher chronological table item 84. When it is determined that the input selected on the study result information selection menu screen 81 is the researcher chronological table item 84, the system performs a subject of study chronological table process in step S86, thereby presenting a researcher chronological table screen 92 on the user terminal as illustrated in FIG. 30. The results of the recent studies classified according to researcher are thus disclosed. If the study subject 88 is selected on the subject of study chronological table screen 91 using the mouse, etc., the study result display screen 89 is presented as illustrated in FIG. 28. If the return button 90 is pressed on the study result display screen 89, the routine loops to step S82. When it is determined in step S87 that the input selected on the study result information selection menu screen 81 is not the researcher chronological table item 84, the routine proceeds to step S89.

In step S89, the system determines whether the input selected on the study result information selection menu screen 81 is the keyword item 85. When it is determined that the input selected on the study result information selection menu screen 81 is the keyword item 85, the system performs a keyword searching process in step S90, thereby presenting a keyword searching list screen 93 on the user terminal as illustrated in FIG. 31. The results of keyword searching are thus disclosed. If the searched study subject 88 is selected on the keyword searching list screen 93 using the mouse, etc., the study result display screen 89 is presented on the user terminal as illustrated in FIG. 28. If the return button 90 is pressed on the study result display screen 89, the routine loops to step S82. When it is determined in step S89 that the input selected on the study result information selection menu screen 81 is not the keyword item 85, the input item must be the quit menu 86. The system them ends the process, and returns to step S42 shown in FIG. 10.

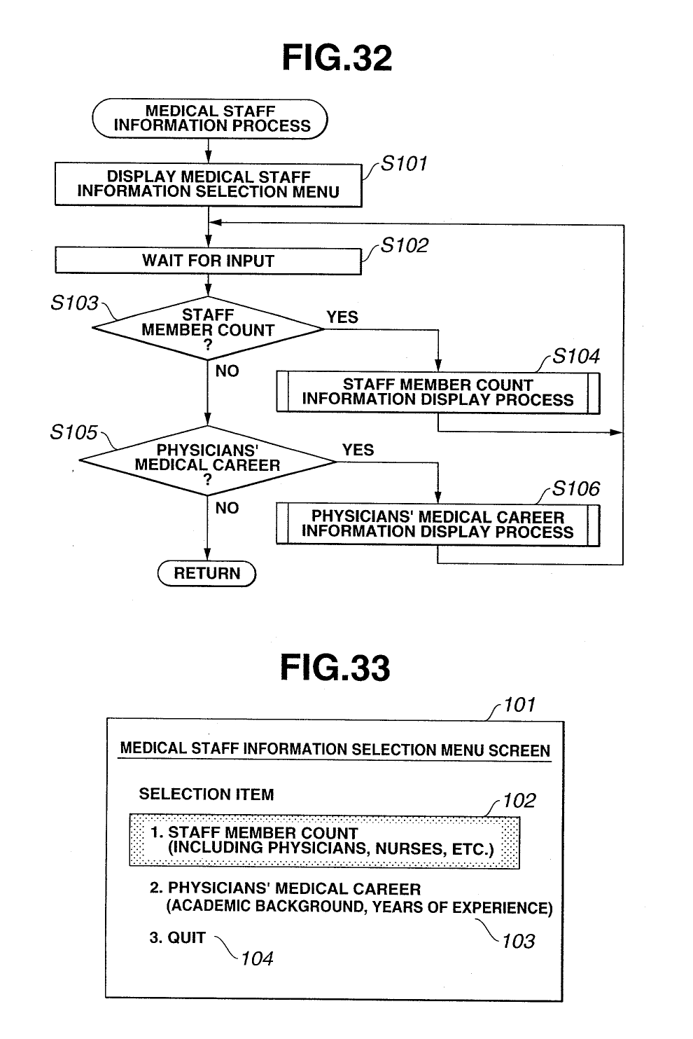

The medical staff information process in step S48 illustrated in FIG. 10 is discussed hereinafter. In the medical staff information process, a medical staff information selection menu screen 91 shown in FIG. 33 is presented on the user terminal in step S101 as illustrated in FIG. 32.

The medical staff information selection menu screen 101 lists a staff member count item 102 for disclosing the number of staff members in the searched hospital, a physician's medical career item 103 for disclosing the academic background, years of experience, etc. of a physician, and a quit menu 104 for quitting the medical staff information process. The user selects each of these items using the keyboard or the mouse. In step S102, the system waits for an input selected by the user.

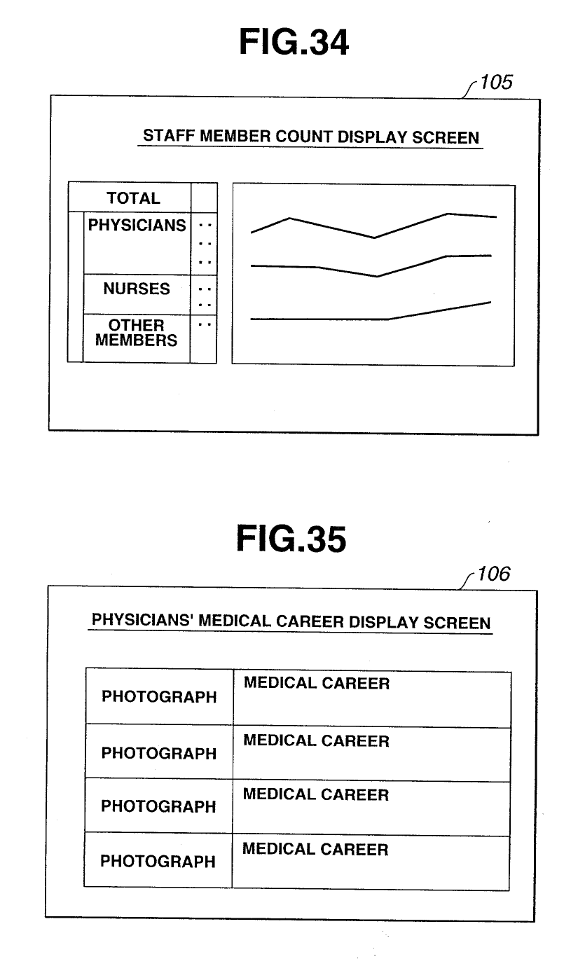

In step S103, the system determines whether the input selected on the medical staff information selection menu screen 101 is the staff member count item 102. When it is determined that the input selected on the medical staff information selection menu screen 101 is the staff member count item 102, the system performs a medical staff member count information display process in step S104, thereby presenting a medial staff member count display screen 105 on the user terminal as illustrated in FIG. 34. A staff member count of all staff members, classified into physicians, nurses, and other staff members, is thus disclosed. The change in the staff member count is disclosed in a graph. If a return button 106 is pressed on the medial staff member count display screen 105, the routine loops to step S102. When it is determined in step S103 that the input selected on the medical staff information selection menu screen 101 is not the staff member count 102, the routine proceeds to step S105.

In step S105, the system determines whether the input selected on the medical staff information selection menu screen 101 is the physician's medical career item 103. When it is determined that the input selected on the medical staff information selection menu screen 101 is the physician's medical career item 103, the system performs a physician's medical career display process in step S106, thereby presenting a physician's medical career display screen 106 on the user terminal as illustrated in FIG. 35. The medical career of each physician is thus disclosed. If a return button 107 is pressed on the physician's medical career display screen 106, the routine loops to step S102. When it is determined in step S105 that the input selected on the medical staff information selection menu screen 101 is not the physician's medical career item 103, the selected input must be the quit menu 104. The system then ends the process, and returns to step S42 illustrated in FIG. 10.

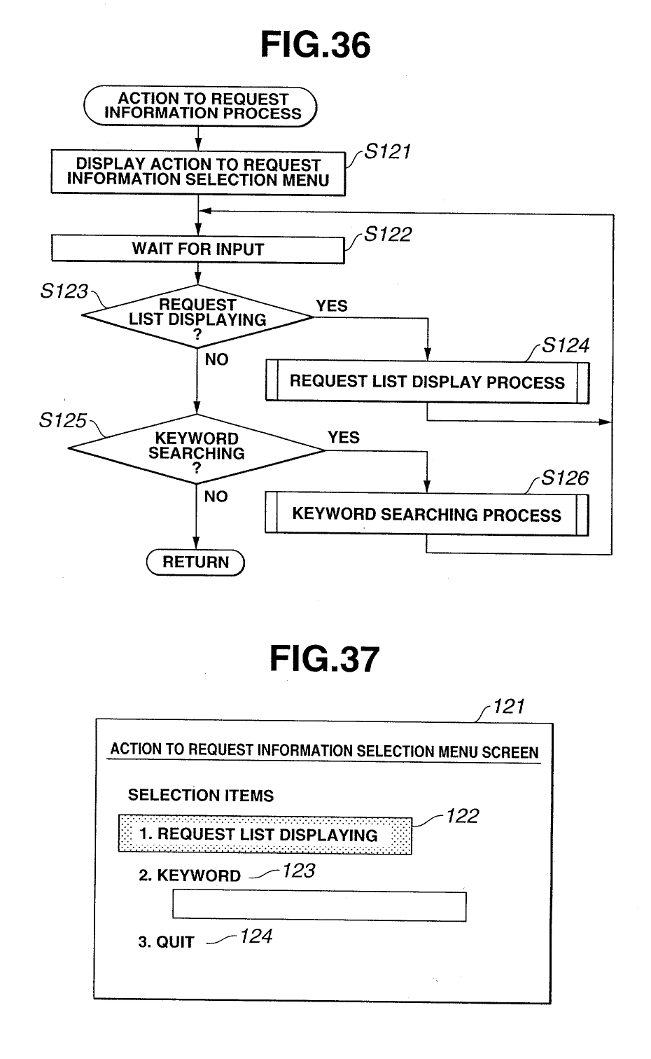

The action to request process in step S54 illustrated in FIG. 10 is discussed hereinafter. In the action to request process, an action to request information selection menu 121 illustrated in FIG. 37 is presented on the user terminal in step S121 as illustrated in FIG. 36.

The action to request information selection menu 121 lists selection items for disclosing the action to a request in the searched hospital. These selection items include a request list item 122 in which a list of all requests is viewed, a keyword item 123 in which the requests are searched by a keyword, and a quit menu 124 for quitting the action to request information process. The user selects each of these items using the keyboard or the mouse. By entering a keyword, the user searches for information about the action to request. In step S122, the system waits for an input selected by the user in step S122.

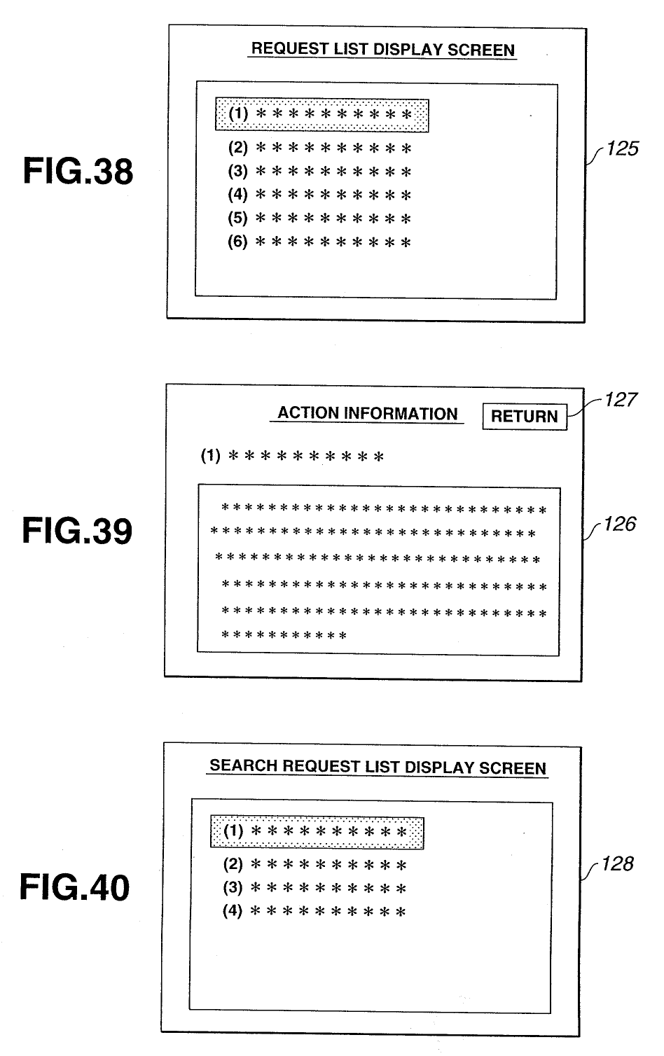

In step S123, the system determines whether the input selected on the action to request information selection menu 121 is the request list item 122. When it is determined that the input selected on the action to request information selection menu 121 is the request list item 122, the system performs a request list display process in step S124, thereby presenting a request list display screen 125 on the user terminal as illustrated in FIG. 38. By selecting a request displayed on the request list display screen 125, an action to request information screen 126 is displayed and thus disclosed on the user terminal as illustrated in FIG. 39. If a return button 127 is pressed on the action to request information screen 126, the routine loops to step S122. When it is determined in step S123 that the input selected on the action to request information selection menu 121 is not the request list item 122, the routine proceeds to step S125.

In step S125, the system determines whether the input selected on the action to request information selection menu 121 is a keyword in the keyword item 123. When it is determined that the input selected on the action to request information selection menu 121 is a keyword in the keyword item 123, the system performs a keyword searching process in step S126, thereby presenting a search request list screen 128 on the user terminal as illustrated in FIG. 40. The results of search are thus disclosed. When a searched request is selected on the search request list screen 128 using the mouse, etc., the action to request information screen 126 is presented on the user terminal as illustrated in FIG. 39. If the return button 127 is pressed on the action to request information screen 126, the routine loops to step S122. When it is determined in step S125 that the input selected on the action to request information selection menu 121 is not a keyword in the keyword item 123, the selected input must be the quit menu 124. The system then ends the process, and returns to step S42 illustrated in FIG. 10.

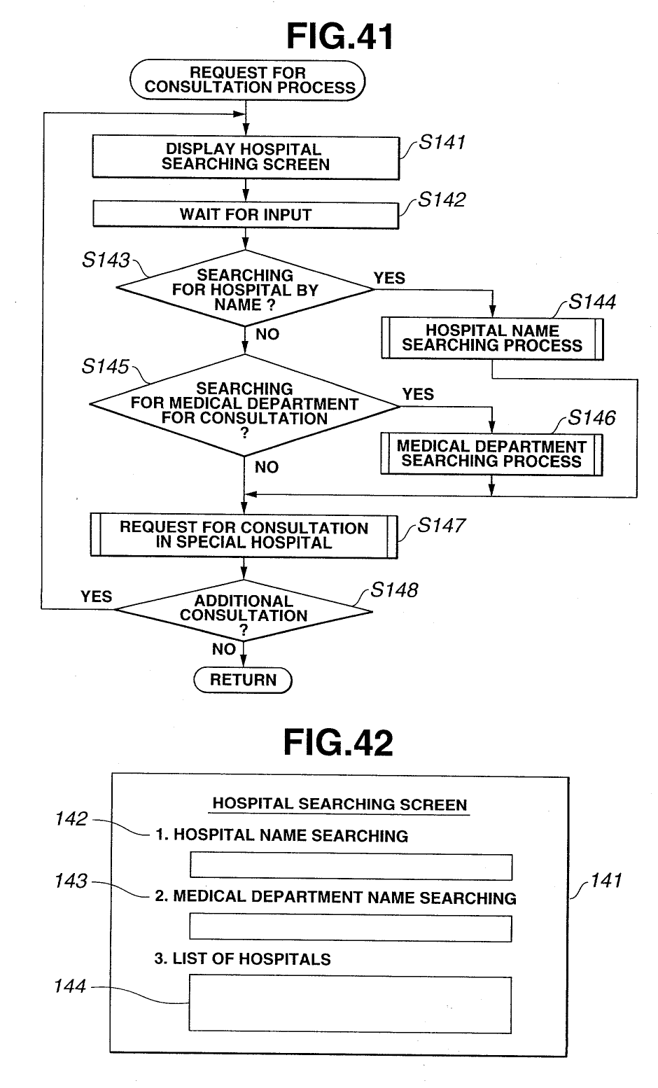

The request for consultation process in step S6 in FIG. 3 or in step S31 in FIG. 6 is discussed hereinafter. In the request for consultation, a hospital searching screen 141 illustrated in FIG. 42 is presented on the user terminal in step S141 as illustrated in FIG. 41.

The hospital searching screen 141 lists a hospital name searching item 142 in which the name of a hospital to be searched for by name is input, and a medical department name searching item 143 in which a medical department name is input to search for hospitals by medical department. The user searches for the hospitals by entering the name of a hospital or the name of a medical department. The system waits for an input selected by the user in step S142.

In step S143, the system determines whether the input selected on the hospital searching screen 141 is a hospital name. When it is determined that input selected on the hospital searching screen 141 is a hospital name, the system performs a hospital name searching process in step S144, thereby presenting search results in a hospital name list display area 144 on the hospital searching screen 141. When it is determined in step S143 that input selected on the hospital searching screen 141 is not a hospital name, the routine proceeds to step S145.

In step S145, the system determines whether the input selected on the hospital searching screen 141 is a medical department name. When it is determined that the input selected on the hospital searching screen 141 is a medical department name, the system performs a hospital name searching process in step S146, thereby presenting search results in the hospital name list display area 144 on the hospital searching screen 141. When it is determined in step S145 that the input selected on the hospital searching screen 141 is not a medical department name, the routine proceeds to step S147.

In the request for consultation process in step S31 illustrated in FIG. 6, the hospitals are already searched, and the search results are displayed in the hospital name list display area 144. The routine proceeds directly to step S147 from step S141.

When a hospital shown in the hospital name list display area 144 is selected using the mouse, etc., the system performs a consultation request for special hospital process to be discussed later in step S147. When another request is made in step S148, the routine loops to step S141. When no further request is made, the system ends the process.

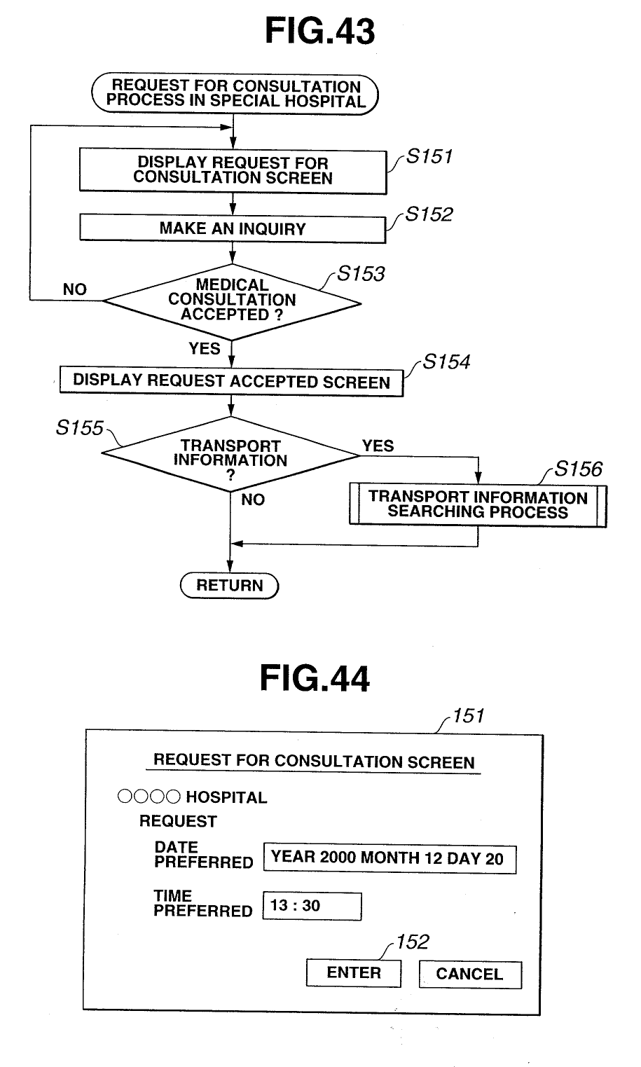

In the consultation request for special hospital process in step S147 illustrated in FIG. 40, a request for consultation screen 151 illustrated in FIG. 44 is presented on the user terminal in step S151 as illustrated in FIG. 43. When an enter button 152 is clicked with the mouse, etc., With a consultation date input on the request for consultation screen 151, an inquiry about the request for consultation is made to the hospital selected in step S152.

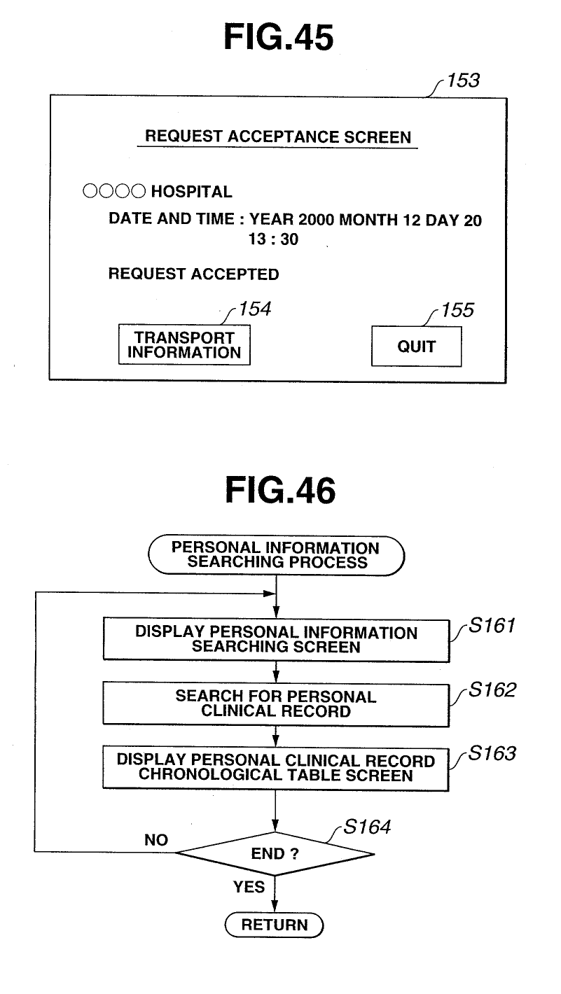

The system determines in step S153 whether the request for consultation is accepted in response to the inquiry. When it is determined that the request for consultation is not acceptable, the routine loops to step S151, else a request acceptance screen 153 illustrated in FIG. 45 is presented on the user terminal in step S154. The routine then proceeds to step S155.

In step S155, the system determines whether a transport information button 154 has been pressed on the request acceptance screen 153 to acquire the transport information or determines whether a quit button 155, has been pressed on the request acceptance screen 153 to quit the process. When it is determined that the transport information button 154 has been pressed, the system performs, in step S156, a transport information searching process to be discussed later. When it is determined that the quit button 155 has been pressed, the system then ends the process.

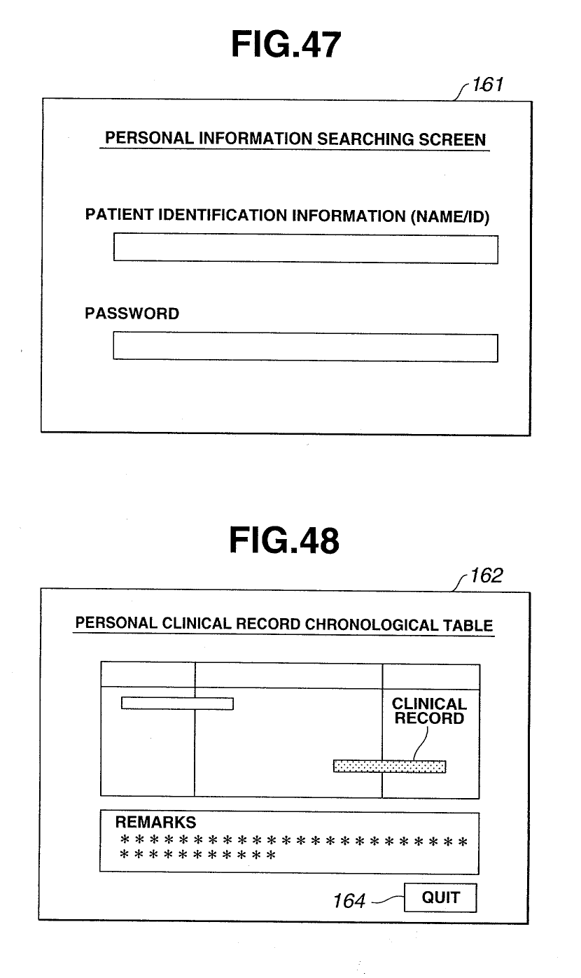

The personal information searching process in step S8 illustrated in FIG. 3 is discussed hereinafter. In the personal information searching process, a personal information searching screen 161 illustrated in FIG. 47 is presented on the user terminal in step s161 as illustrated in FIG. 47. When the user inputs patient identification information (the name or ID of a patient) for identifying the patient and a password, the clinical record of the patient is searched for in step S162. A personal clinical record chronological table screen 162 shown in FIG. 48 is presented on the user terminal in step S163.

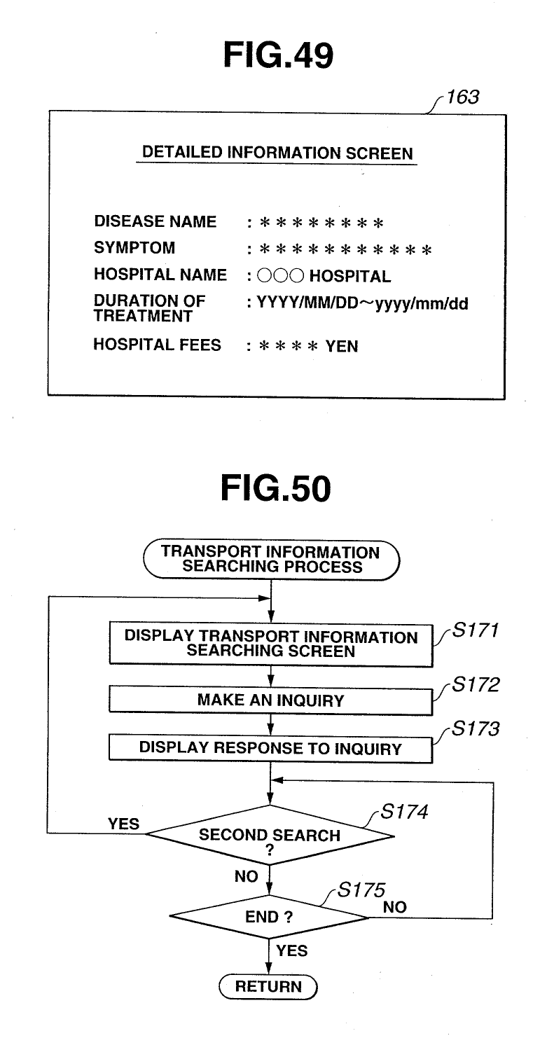

When a personal clinical record is selected on the personal clinical record chronological table screen 162, a detailed information screen 163 listing detailed information about the personal clinical record is presented on the user terminal as shown in FIG. 49.

When it is determined in step S164 that a quit button 164 is clicked on the personal clinical record chronological table screen 162, the system ends the process.

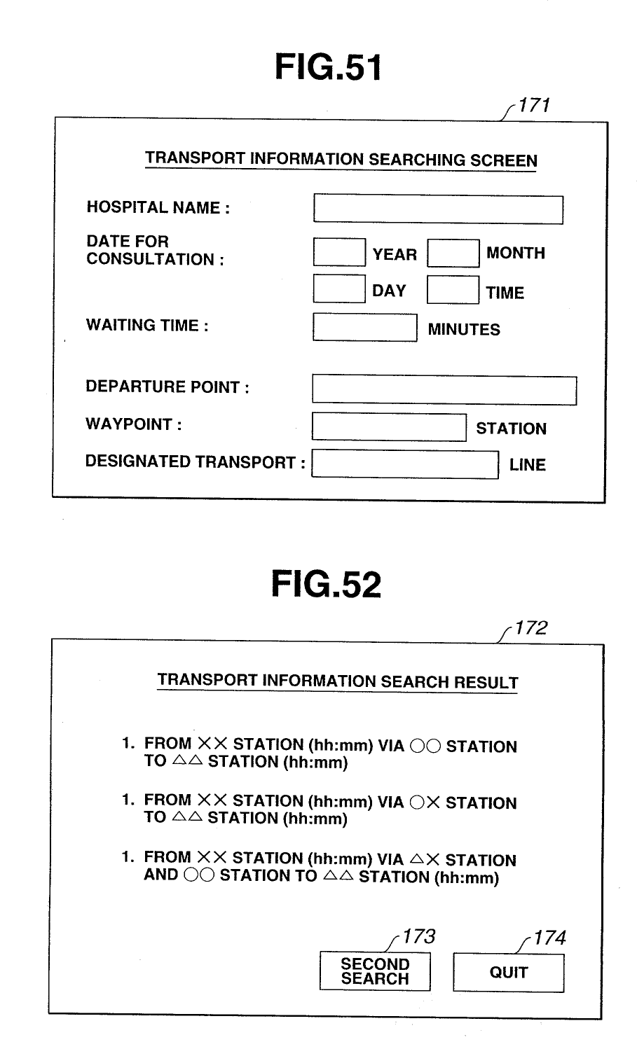

The transport information searching process in step S10 in FIG. 3 or in step S156 in FIG. 43 will be now discussed. In the transport information searching process, a transport information searching screen 171 illustrated in FIG. 51 is presented on the user terminal in step S171 as illustrated in FIG. 50. The user inputs information such as the name of a hospital, the date of medical consultation, waiting time, a departure point, a waypoint, and a designated transport, transports are then searched for in step S172.

In the transport information searching process in step S156 in FIG. 43, the request is accepted, and the name of the hospital, the date of consultation, and the waiting time are automatically displayed on the transport information searching screen 171.

In step S173, a transport information search result screen 172 listing A plurality of appropriate pieces of transport information to the hospital illustrated in FIG. 52 is presented on the user terminal in step S173.

In step S174, the system determines whether a second search button 173 has been pressed on the transport information search result screen 172. When it is determined that the second search button 173 has been pressed on the transport information search result screen 172, the routine loops to step S171. When it is determined the second search button 173 has been not pressed on the transport information search result screen 172, the system waits until a quit button 174 is clicked on the transport information search result screen 172 in step S175. When the quit button 174 is clicked, the system ends the process.

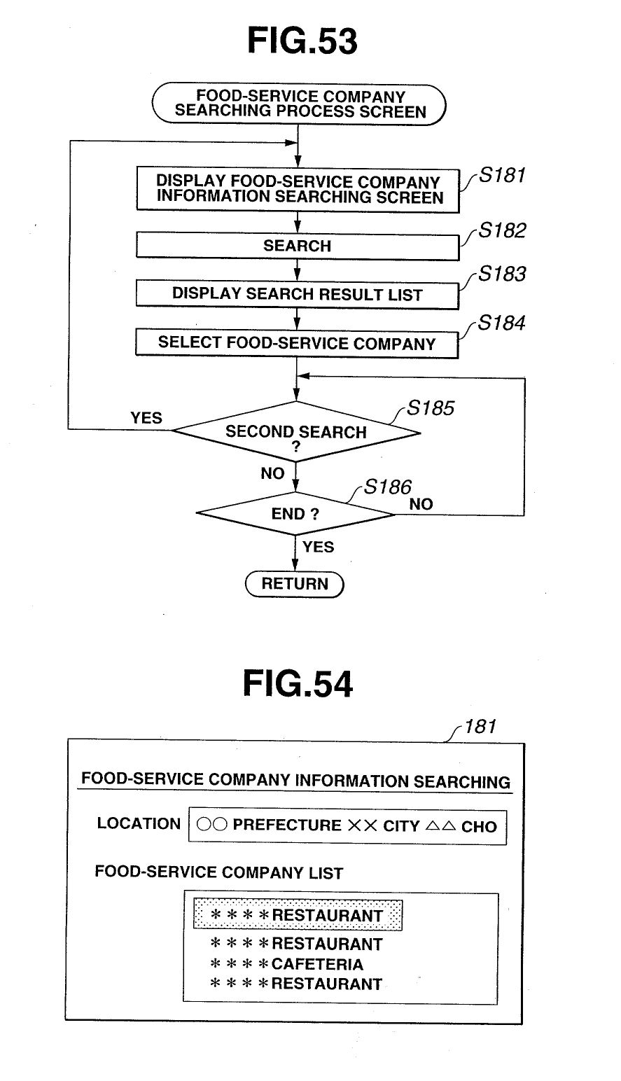

The food-service company information searching process in step S12 illustrated in FIG. 3 is discussed hereinafter. In the food-service company information searching process, a food-service company information searching screen 181 illustrated in FIG. 54 is presented on the user terminal in step S181 as illustrated in FIG. 53. When the user inputs a local area name on the food-service company information searching screen 181, food-service company names are searched for in step S182. The names of food-service companies (such as restaurants) present in the local area are displayed on the food-service company information searching screen 181.

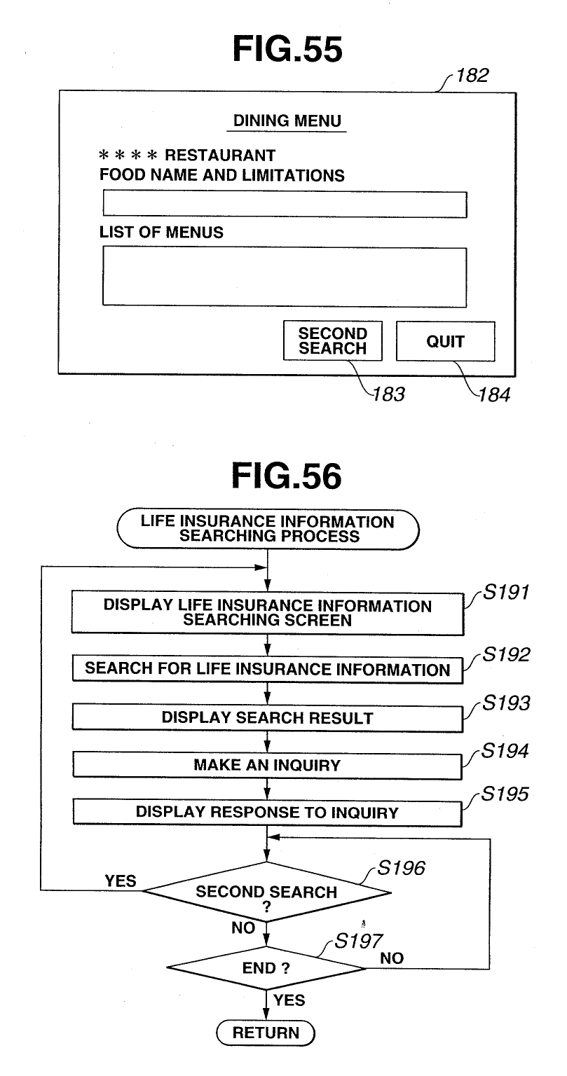

When the name of a food-service company displayed in step S183 is clicked, the user terminal displays a dining menu screen 182 in which the dining menu of foods provided by the food-service company illustrated in FIG. 55 is searched for. When the user inputs the name of food or a limitation on food instructed by physicians or the like on the dining menu screen 182, a menu appropriate for the user. is searched for, and is displayed in a menu list on the dining menu screen 182.

In step S184, the system determines whether a second search button 183 has been pressed on the dining menu screen 182. When it is determined that the second search button 183 has been pressed on the dining menu screen 182, the routine loops to step S181. When it is determined that the second search button 183 has not been pressed on the dining menu screen 182, the system waits until a quit button 174 is clicked on the dining menu screen 182 in step S185. When the quit button 184 is clicked, the system ends the process.

The user eats food in accordance with the dining menu displayed in the dining menu screen 182, and limitations on caloric intake and salt intake, which are typically difficult to control in normal food service, are appropriately observed.

The food-service companies include providers which supply hotels with food. A user, who is on a diet, enjoys food safely and at ease in accordance with the dining menu displayed on the dining menu screen 182, for example, during a travel.

The limitations on food may be coded, and food available at convenience stores may be supplied in accordance with the coded limitations. In this way, the user enjoys food at ease.

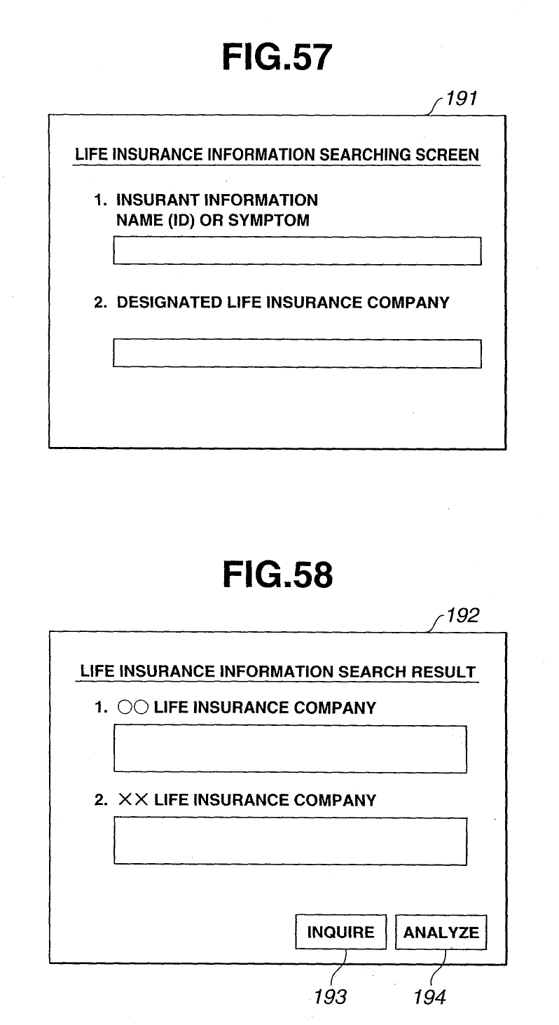

The life insurance information searching process in step S14 illustrated in FIG. 3 is now discussed. In the life insurance information searching process, a life insurance information searching screen 191 illustrated in FIG. 57 is presented on the user terminal in step S191 as illustrated in FIG. 56. The user may input the name or ID or the symptom of the user as insurant information to search for insurance on the life insurance information searching screen 191. Furthermore, the user may designate a life insurance company as necessary. The life insurance companies and insurance courses thereof are searched for in step S192. In step S193, a life insurance information search result screen 192 illustrated in FIG. 58 is presented on the user terminal in step S193.

When an inquiry button 193 or an analyze button 194 is clicked on the life insurance information search result screen 192, an inquiry about a life insurance course is made to a life insurance company.

The analyze button 194 is clicked to compare a current life insurance course of the user with searched life insurance. When the analyze button 194 is clicked, the user terminal displays, in step S195, a reply to an inquiry screen such as a content comparison screen 201 shown in FIG. which compares the information of the current life insurance course with the information of the searched life insurance course.

In step S196, the system determines whether a second search button 202 has been clicked on a replay to inquiry screen such as the content comparison screen 201. When the second search button 202 has been clicked, the routine loops to step S191. When it is determined in step S196 that the second search button 202 has not been clicked, the system waits until a quit button 203 on the replay to inquiry screen such as the content comparison screen 201 is clicked in step S197. When the quit button 203 is clicked, the system ends the process.

In accordance with this embodiment, the medical institutions are searched by simply inputting the name of a local area and by simply selecting a medical department. The medical practice information of the searched medical institution (such as the medical service records, the results of the studies, the medical staff information in the medical institutions) are accessible for viewing. With the medical practice information, the user finds an appropriate medical institution in a short period of time.

A request for consultation or diagnosis in a hospital is easily made. Since the transport information is also supplied, the user is reliably guided to a desired medical institution.

Since the food-service information such as of the foodservice companies is supplied, the user easily and reliably observes limitations on food.

Having described the preferred embodiments of the invention referring to the accompanying drawings, it should be understood that the present invention is not limited to those precise embodiments, and various changes and modifications thereof could be made by one skilled in the art without departing from the spirit or scope of the invention as defined in the appended claims.

What is claimed is:

1. A medical practice information storage and searching system comprising:
a medical practice information storage unit for receiving medical practice information of a plurality of medical institutions from the plurality of medical institutions through a communication line;
a searching criteria receiving unit for receiving, through the communication line, searching criteria in accordance with which the medical practice information stored in the medical practice information storage unit is searched for; and
an information delivery unit for searching for the medical practice information in the medical practice information storage unit in accordance with the searching criteria received by the searching criteria receiving unit, and for delivering the searched medical practice information through the communication line.

2. A medical practice information storage and searching system according to claim 1, further comprising:
a medical institution information storage unit for receiving medical institution information, identifying a particular medical institution from among the plurality of medical institutions, from the plurality of medical institutions through the communication lines;
a medical institution searching criteria receiving unit for receiving, through the communication line, searching criteria in accordance with which the medical institution information stored in the medical institution information storage unit is searched for; and
a medical institution information delivery unit for searching for the medical institution information in the medical institution information storage unit in accordance with the searching criteria received by the medical institution searching criteria receiving unit, and for delivering the searched medical institution information through the communication line.

3. A medical practice information storage and searching system according to claim 2, further comprising:
a geographic information storage unit for storing geographic information indicating locations of the plurality of medical institutions;
a geographic searching criteria receiving unit for receiving, through the communication line, searching criteria in accordance with which the geographic information stored in the geographic information storage unit is searched for; and
a geographic information delivery unit for searching for the geographic information in the geographic information storage unit in accordance with the searching criteria received by the geographic searching criteria receiving unit, and for delivering the searched geographic information through the communication line.

4. A medical practice information storage and searching system according to claim 1, further comprising:
a request acceptance information storage unit for receiving request acceptance information of the plurality of medical institutions from the plurality of medical institutions through the communication line;
a request acceptance information searching criteria receiving unit for receiving, through the communication line, searching criteria in accordance with which the request acceptance information stored in the request acceptance information storage unit is searched for; and
a request acceptance information delivery unit for searching for the request acceptance information in the request acceptance information storage unit in accordance with the searching criteria received by the request acceptance information searching criteria receiving unit, and for delivering the searched request acceptance information through the communication line.

5. A medical practice information storage and searching system according to claim 1, further comprising:
a personal information storage unit for receiving, from the plurality of medical institutions through the communication line, personal information of patients who receive medical treatments in the plurality of medical institutions;
a personal information searching criteria receiving unit for receiving through the communication line, searching criteria in accordance with which the personal information stored in the personal information storage unit is searched for; and
a personal information delivery unit for searching for the personal information in the personal information storage unit in accordance with the searching criteria received by the personal information searching criteria receiving unit, and for delivering the searched personal information through the communication line.

6. A medical practice information storage and searching system according to claim 1, further comprising:
a transport information storage unit for storing transport information relating to appropriate transportation for the plurality of medical institutions with the transport information linked to the plurality of medical institutions;
a transport searching criteria receiving unit for receiving, through the communication line, searching criteria in accordance with which the transport information relating to the appropriate transportation for the plurality of medical institutions and stored in the transport information storage unit is searched for; and
a transport information delivery unit for searching for the transport information in the transport information storage unit in accordance with the searching criteria received by the transport searching criteria receiving unit, and for delivering the searched transport information through the communication line.

7. A medical practice information storage and searching system according to claim 1, further comprising:
a food-service company information storage unit for storing information of food-service companies which provide appropriate food service to patients who receive medical treatments in the plurality of medical institutions;
a food-service company searching criteria receiving unit for receiving, through the communication line, searching criteria in accordance with which the food-service company information stored in the food service company information storage unit is searched for; and
a food-service company information delivery unit for searching for the food-service company information in the food-service company information storage unit in accordance with the searching criteria received by the food-service company searching criteria receiving unit, and for delivering the searched food-service company information through the communication line.

8. A medical practice information storage and searching system according to claim 1, further comprising:
a life insurance information storage unit for storing information of life insurance which covers patients who receive medical treatments in the plurality of medical institutions;
a life insurance searching criteria receiving unit for receiving, through the communication line, searching criteria in accordance with which the life insurance information stored in the life insurance information storage unit is searched for; and
a life insurance information delivery unit for searching for the life insurance information in the life insurance information storage unit in accordance with the searching criteria received by the life insurance searching criteria receiving unit, and for delivering the searched life insurance information through the communication line.

9. A medical practice information storage and searching system according to claim 1, wherein the medical practice information storage unit comprises a medical service record information storage block for storing medical service record information in the medical institution as the medical practice information;
wherein the searching criteria receiving unit comprises a medical service record information searching criteria receiving block for receiving a medical service record information searching criteria in accordance with which the medical service record information stored in the medical practice information storage unit is searched for; and
wherein the information delivery unit comprises a medical service record information delivery block for searching for the medical service record information in the medical service record information storage block in accordance with the medical service record information searching criteria received by the medical service record information searching criteria receiving block, and for delivering the searched medical service record information through the communication line.

10. A medical practice information storage and searching system according to claim 9, wherein the medical service record information storage block stores patient count information indicating a patient count in the medical institution as the medical service record information.

11. A medical practice information storage and searching system according to claim 9, wherein the medical service record information storage block stores operation count information indicating an operation count of operations conducted by the medical institution as the medical service record information.

12. A medical practice information storage and searching system according to claim 9, wherein the medical service record information storage block stores inpatient count information indicating an inpatient count in the medical institution as the medical service record information.

13. A medical practice information storage and searching system according to claim 9, wherein the medical service record information storage block stores complete cure rate information indicating a complete cure rate in the medical institution as the medical service record information.

14. A medical practice information storage and searching system according to claim 1, wherein the medical practice information storage unit comprises a study result information storage block that stores study result information of studies conducted by the medical institution as the medical practice information;
wherein the searching criteria receiving unit comprises a study result information searching criteria receiving block for receiving study result information searching criteria in accordance with which the study result information stored in the study result information storage block is searched for; and
wherein the information delivery unit comprises a study result information delivery block for searching for the study result information in the study result information storage block in accordance with the study result information searching criteria received by the study result information searching criteria receiving block, and for delivering the searched study result information thought the communication line.

15. A medical practice information storage and searching system according to claim 1, wherein the medical practice information storage unit comprises a medical staff information storage block for storing information of medical staff in the medical institution as the medical practice information;
wherein the searching criteria receiving unit comprises a medical staff information searching criteria receiving block for receiving medical staff information searching criteria in accordance with which the medical staff information stored in the medical staff information storage block is searched for; and
wherein the information delivery unit comprises a medical staff information delivery block for searching for the medical staff information in the medical staff information storage block in accordance with the medical staff information searching criteria received by the medical staff information searching criteria receiving block, and for delivering the searched medical staff information through the communication line.

16. A medical practice information storage and searching system according to claim 15, wherein the medical staff information storage block stores staff member count information indicating the number of staff members in the medical institution.

17. A medical practice information storage and searching system according to claim 15, wherein the medical staff information storage block stores physicians' career information indicating the career of the physicians working for the medical institution.

18. A medical practice information storage and searching system according to claim 1, wherein the medical practice storage unit comprises a medical facility information storage block for storing information of a medical facility in the medical institution as the medical practice information;
wherein the searching criteria receiving unit comprises a medical facility information searching criteria receiving block for receiving a medical facility information searching criteria in accordance with which the medical facility information stored in the medical facility information storage block is searched for; and
wherein the information delivery unit comprises a medical facility information delivery block for searching for the medical facility information in accordance with the medical facility information searching criteria received by the medical facility information searching criteria receiving block, and for delivering the searched medical facility information through the communication line.

19. A medical practice information storage and searching system according to claim 1, wherein the medical practice information storage unit comprises a medicine information storage block for storing information of medicines used in the medical institution as the medical practice information;
wherein the searching criteria receiving unit comprises a medicine information searching criteria receiving block for receiving medicine information searching criteria in accordance with which the medicine information stored in the medicine information storage block is searched for; and
a medicine information delivery block for searching for the medicine information in accordance with the medicine information searching criteria received by the medicine information searching criteria receiving block, and for delivering the searched medicine information through the communication line.

20. A medical practice information storage and searching method comprising:
a medical practice information storage step for receiving medical practice information of a plurality of medical institutions from the plurality of medical institutions through a communication line and storing the medical practice information into a medical storage unit;
a searching criteria receiving step for receiving, at a searching criteria receiving unit through the communication line, searching criteria in accordance with which the medical practice information stored in the medical practice information storage unit is searched for;
a medical information searching step for searching for the medical practice information in the medical practice information storage unit in accordance with the searching criteria received by the searching criteria receiving unit; and
an information delivery step for delivering the medical practice information, searched in the medical information searching step, through the communication line.

21. A medical practice information storage and searching system comprising:
a first medical practice information input unit, arranged in a first medical institution, for inputting fact information about medical practice conducted by the first medical institution as first medical practice information;
a first medical practice information transmitter for transmitting, through a communication line, the first medical practice information input by the first medical practice information input unit;
a second medical practice information input unit, arranged in a second medical institution, for inputting fact information about medical practice conducted by the second medical institution as second medical practice information;
a second medical practice information transmitter for transmitting, through the communication line, the second medical practice information input by the second medical practice information input unit;
a medical practice information receiver for receiving, through the communication line, the first medical practice information transmitted from the first medical practice information transmitter and the second medical practice information transmitted from the second medical practice information transmitter;
a medical practice information storage unit for storing the first and second medical practice information received by the medical practice information receiver;
a medical practice searching information input unit for inputting searching command information that provides a command to search for the first and second medical practice information stored in the medical practice information storage unit;
a searching command information transmitter for transmitting the searching command information, input by the medical practice searching information input unit, through the communication line;
a searching command information receiver for receiving the searching command information, transmitted by the searching command information transmitter, through the communication line;
a medical practice information searching unit for searching for the first and second medical practice information stored in the medical practice information storage unit in accordance with the searching command information received by the searching command information receiver;
a search result information transmitter for transmitting the search result, provided by the medical practice information searching unit, through the communication line;
a search result information receiver for receiving the search result, transmitted by the search result information transmitter, through the communication line; and
a search result display unit for displaying the search result received by the search result information receiver on display means.

22. A medical practice information storage and searching method comprising:
first medical practice information input step for inputting first medical practice information from a first medical practice information input unit that inputs fact information about medical practice conducted by a first medical institution as the first medical practice information;
a first medical practice information transmitting step for transmitting, through a communication line, the first medical practice information input in the first medical practice information input step;
a second medical practice information input step for inputting second medical practice information from a second medical practice information input unit that inputs fact information about medical practice conducted by a second medical institution as the second medical practice information;
a second medical practice information transmitting step for transmitting, through the communication line, the second medical practice information input in the second medical practice information input step;
a medical practice information receiving step for receiving, through the communication line, the first medical practice information transmitted in the first medical practice information transmitting step and the second medical practice information transmitted in the second medical practice information transmitting step;
a medical practice information storage step for storing the first and second medical practice information received in the medical practice information receiving step;
a medical practice searching information input step for inputting searching command information that provides a command to search for the first and second medical practice information stored in the medical practice information storage unit;
a searching command information transmitting step for transmitting the searching command information, input in the medical practice searching information input step, through the communication line;
a searching command information receiving step for receiving the searching command information, transmitted in the searching command information transmitting step, through the communication line;
a medical practice information searching step for searching for the first and second medical practice information stored in the medical practice information storage means in accordance with the searching command information received in the searching command information receiving step;
a search result information transmitting step for transmitting the search result provided in the medical practice information searching step through the communication line;
a search result information receiving step for receiving the search result transmitted in the search result information transmitting step through the communication line; and
a search result displaying step for displaying the search result received in the search result information receiving step on a display unit.
